(19) United States
(12) Patent Application Publication
(10) Pub. No.: US 2017/0046804 A1
(43) Pub. Date: Feb. 16, 2017

(54) METHOD AND SYSTEM FOR CREATING AN ENDURING HABITAT

(71) Applicant: RONN T. SLAY, Atwater, CA (US)

(72) Inventor: RONN T. SLAY, Atwater, CA (US)

(21) Appl. No.: 15/338,177

(22) Filed: Oct. 28, 2016

Related U.S. Application Data
(63) Continuation-in-part of application No. 11/100,288, filed on Apr. 5, 2005.
Application No. 11/100,288 is a continuation-in-part of application No. 15/210,862, filed on Jul. 14, 2016.
Application No. 15/210,862 is a continuation-in-part of application No. 11/100,288, filed on Apr. 5, 2005.
(60) Provisional application No. 60/560,404, filed on Apr. 8, 2004.
(60) Provisional application No. 60/560,404, filed on Apr. 8, 2004.

(51) Int. Cl. G06Q 50/16; G06Q 50/26; G06Q 40/06

(52) U.S. Cl. CPC G06Q 50/165; G06Q 40/06; G06Q 50/26

(57) ABSTRACT

A system for mitigating the loss of a species is disclosed. The system may have a digging implement to move earth in order to create a mitigation habitat on a mitigation property. The mitigation property being located on real property where Native American artifacts or remains are buried. Creating the habitat may include removing invasive species, importing species into the habitat, modifying the water system on the property, erecting fences, building a cultural center, and/or creating walkways, for example.

### CROSS-REFERENCE TO RELATED APPLICATIONS

This application is a continuation-in-part of U.S. application Ser. No. 15/210,862 (Docket Number AP-3), entitled, “METHOD AND SYSTEM FOR CREATING AN ENDURING HABITAT,” filed Jul. 14, 2016, by Ronn T. Slay, which is a continuation in part of Ser. No. 11/100,288 (Docket Number AP-2), entitled, “Perpetual funding method for mitigating impacts on public infrastructure projects,” filed Apr. 5, 2005, by Ronn T. Slay, which claims priority to Provisional Application No. 60/560,404 (Docket Number AP-1), entitled “Perpetual funding method for mitigating impacts of public infrastructure projects,” filed Apr. 8, 2004, by Ronn T. Slay; this application is also a continuation-in-part of U.S. application Ser. No. 11/100,288 (Docket # AP-2), entitled, “Perpetual funding method for mitigating impacts on public infrastructure projects,” filed Apr. 5, 2005, by Ronn T. Slay, which claims priority to Provisional Application No. 60/560,404 (Docket Number AP-1), entitled “Perpetual funding method for mitigating impacts of public infrastructure projects,” filed Apr. 8, 2004, by Ronn T. Slay, which are all incorporated herein by reference, in their entirety.

### FIELD

This specification generally relates to methods and systems for creating habitats.

### BACKGROUND

The subject matter discussed in the background section should not be assumed to be prior art merely as a result of its mention in the background section. Similarly, a problem and the understanding of the causes of a problem mentioned in the background section or associated with the subject matter of the background section should not be assumed to have been previously recognized in the prior art. The subject matter in the background section may merely represents different approaches, which in and of themselves may also be inventions.

Many state and federal statutes require government agencies to mitigate the environmental impacts of new infrastructure projects upon local wildlife habitats, archeological sites, spiritual sites or natural resources. The particular mitigation requirement depends upon the acreage and value of the land impacted by the particular public project. The amount and type of mitigation necessary to satisfy such requirements depends upon the particular characteristics of the mitigation.

Locating the land, determining the optimal combination of characteristics to satisfy the mitigation requirement, and developing and maintaining the mitigation bank is an expensive and time-consuming process. Many “land banking” companies prepare properties for such purposes. Unfortunately, many land banking companies do not carefully administer endowments. Instead, the land banking companies deplete the endowment with high development and administrative fees and costs, leaving little money to maintain the habitat for any length of time, much less perpetually.

Once the endowment is exhausted, the habitat is generally ignored by the company and left to fall into disrepair. Alternatively, and commonly, the company may transfer the habitat to a state or federal agency responsible for habitat management, thereby creating a significant burden upon taxpayers. Accumulations of projects with depleted endowments will have a significant effect upon the government's ability to fund additional public infrastructure projects, or any projects at all.

The nature of the land used for mitigation projects does not inherently protect the newly developed or restored habitats from future loss of habitat due to future land development. Furthermore, the government agencies charged with monitoring the development, maintenance and administration of mitigation banks generally do not have the resources to adequately monitor development beyond completion of the public project. Such agencies may lack the time and/or resources necessary to regularly update and maintain information concerning the particular species supported by a habitat, or the agencies may have to convert existing habitats to support popular species, thereby displacing the former supported species. Thus, the land chosen and the entities charged with maintaining the mitigation property are insufficient to create an enduring mitigation property.

Additionally, the mitigating company or agency must have a perpetual funding means to ensure that any adverse changes to the site conditions are corrected or mitigated as soon as possible. Such close monitoring is difficult or impossible with the current method of financing and maintaining mitigation properties.

Also, the development projects often fail to consider the impact of development activities on Native American cultural artifacts. For instance, in order to build a hydroelectric dam, real property is often flooded. When the real property is flooded, it is common that the remains of Native Americans are washed up, disrespecting the remains and cultural artifacts, which were safely buried before the development. Often, repatriating items of Native American cultural importance presents a cost-prohibitive burden on a development project and can entirely defeat a given project.

### BRIEF DESCRIPTION OF THE FIGURES

In the following drawings, like-reference numbers refer to like elements. Although the following figures depict various examples of the invention, the invention is not limited to the examples depicted in the figures.

FIG. 1 shows a block diagram of an embodiment of a system for creating or restoring an enduring habitat for mitigation.

FIG. 2 shows a block diagram of an embodiment of a system of activities and structures used to create a mitigation habitat.

FIG. 3 shows a flowchart of an embodiment of a method for creating a mitigation property from the perspective of a mitigating entity.

FIG. 4 shows a flowchart of an embodiment of a method for creating a mitigation property on Native American lands from the perspective of mitigating entity.

FIG. 5 shows a flowchart of an embodiment of a method for creating a mitigation property from the perspective of a constructing entity.

FIG. 6A shows a flowchart of an embodiment of a method for creating a mitigation property from the perspective of a governmental entity.

FIG. 6B shows an example of a habitat.

FIG. 6C shows an example of a public infrastructure project, which may be used in the system of FIG. 1.

FIG. 6D shows an embodiment of a magnetometer, which may be used to detect items of significance to Native Americans and/or archeologists.

FIG. 6E shows an embodiment of ground penetrating radar, which may be used to detect items of significance to Native Americans and/or archeologists.

FIG. 6F shows an embodiment of sonar system, which may be used to detect items of significance to Native Americans and/or archeologists.

FIG. 6G shows an embodiment of a resistance meter, which may be used to detect items of significance to Native Americans and/or archeologists.

FIG. 7 shows an embodiment of a digging activity to create a mitigation property.

FIG. 8 shows an embodiment of diverting water to create a mitigation property.

FIG. 9 shows an embodiment of a building activity to create a mitigation property.

FIG. 10 shows an embodiment of erecting or repairing a fence, which may establish structural boundaries for portions of the mitigation property.

FIG. 11A shows an embodiment of removing local invasive species to create a mitigation property.

FIG. 11B shows bringing a desired animal species to a habitat, via a vehicle, to a habitat.

FIG. 11C shows releasing the desired animal species into the habitat.

FIG. 11D shows removing an invasive animal species from a habitat.

FIG. 11E1 shows transporting the invasive species animal out of the habitat to another location, via a vehicle, after the invasive species is removed from the habitat.

FIG. 11E2 shows bringing a desired animal species to a habitat, via a vehicle, to a habitat.

FIG. 11E3 shows the actual releasing the desired animal species into the habitat.

FIG. 11F shows removing water from a body of water, which may be used a way of removing an invasive species.

FIG. 11G shows introducing a desired species of plant to a habitat.

FIG. 11H shows another embodiment of removing and/or introducing a species to a habitat.

FIG. 11I shows an example of repatriating Native American remains and/or artifacts in the habitat.

FIG. 12 shows an embodiment of erecting a cultural structure to create a multiuse mitigation property.

FIG. 13 shows an embodiment of creating a shelter reintroducing a species that is not present or that is present in relatively small numbers to create a mitigation property.

FIG. 14 shows an embodiment of filling existing water basins to create a mitigation property.

FIG. 15 shows an embodiment of removing archeologically sensitive material to create a mitigation property.

FIG. 16 shows a block diagram of an embodiment of a computer system.

FIG. 17 shows a block diagram of an embodiment of a controller system.

FIG. 18 shows a block diagram of an embodiment of the memory of a mitigating entity computer system.

FIG. 19 shows a block diagram of an embodiment of the memory of a mitigating entity financial institution computer system.

FIG. 20 shows a block diagram of an embodiment of the memory of a development entity server.

FIG. 21 shows a block diagram of an embodiment of the memory of a development entity financial institution computer system.

FIG. 22 shows a block diagram of an embodiment of the memory of a governmental entity server.

FIG. 23 shows a block diagram of an embodiment of the memory of a governmental entity financial institution computer system.

FIG. 24 shows an embodiment of a method for managing endowments.

FIG. 25 shows a computerized spreadsheet of an embodiment of the financials associated with a mitigation property.

FIG. 26 shows another computerized spreadsheet of an embodiment of a pro forma budget for a wetland restoration project.

FIG. 27 shows a flowchart of an embodiment of a method for repatriating Native American remains or cultural artifacts.

FIG. 28A shows a diagram of an embodiment a flashboard riser.

FIG. 28B shows an embodiment of a flashboard riser.

FIG. 29A shows an embodiment of a system for a reservoir.

FIG. 29B shows an embodiment of a concrete riser control valve with pipeline vent.

FIG. 29C shows an embodiment of a concrete valve with a view of a cap screw valve cover.

FIG. 30 shows an embodiment of a weir control structure.

FIG. 31 also shows an embodiment of a weir control structure with weir boards.

FIG. 32 shows an embodiment of a view of a screw valve control gate.

FIGS. 33-36 show the screw wheel and screw of other screw valves.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just address one deficiency that may be discussed in the specification, and some embodiments may not address any of these deficiencies.

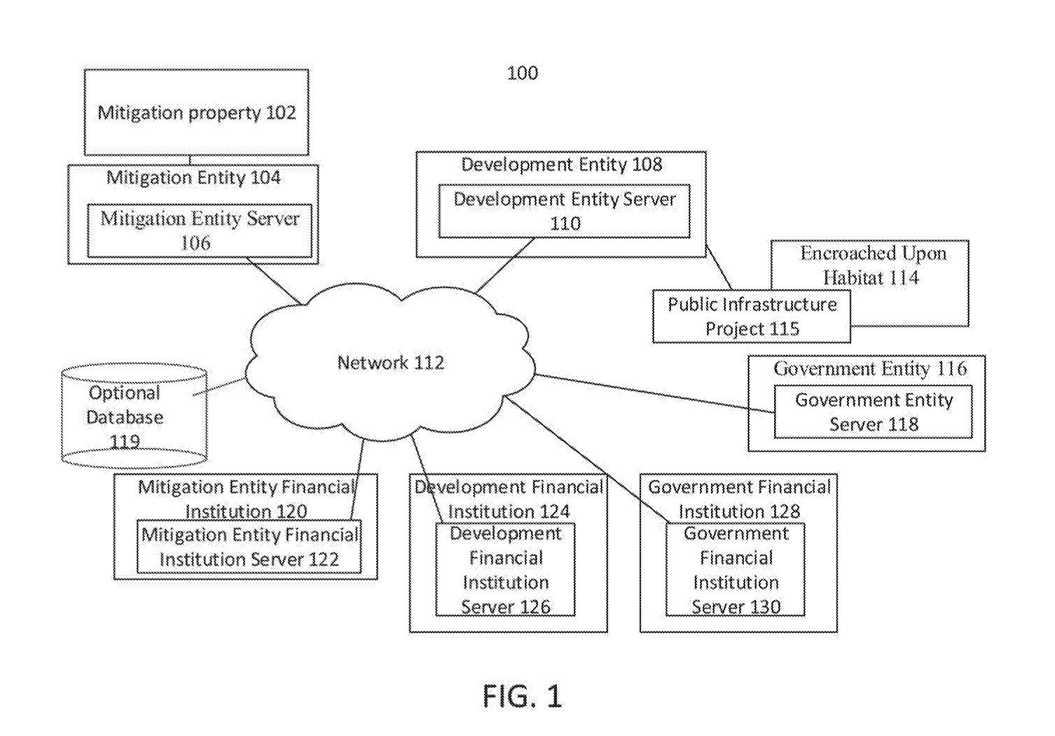

In general, at the beginning of the discussion of each of FIGS. 1-36 is a brief description of each element, which may have no more than the name of each of the elements in the FIGS. 1-36 that is being discussed. After the brief description of each element, each element is further discussed in numerical order. In general, each of FIGS. 1-36 is discussed in numerical order and the elements within FIGS. 1-36 are also usually discussed in numerical order to facilitate easily locating the discussion of a particular element. Nonetheless, there is no one location where all of the information of any element of FIGS. 1-36 is necessarily located. Unique information about any particular element or any other aspect of any of FIGS. 1-36 may be found in, or implied by, any part of the specification.

FIG. 1 shows a block diagram of an embodiment of a system for creating or restoring an enduring habitat for mitigation. The system 100 may include a mitigation property 102, a mitigation entity 104, a mitigation entity server 106, a development entity 108, a development entity server 110, a network 112, development property 115, an encroached upon habitat 114, a development property 115, a government entity 116, a government entity server 118, a database 119, a mitigation entity financial institution 120, a mitigation entity financial institution server 122, a development financial institution 124, and a development financial institution server 126. In other embodiments, the system 100 may not have all of the elements listed and/or may have other elements in addition to or instead of those listed.

System 100 establishes or restores habitats as mitigation for damaging another habitat. Mitigation is the act of lessening the environmental impact of development projects by offsetting damage of a particular habitat by restoring or creating another habitat at a location other than the location of the development. The newly created or restored habitat may be similar to, or different from, the damaged habitat. For example, wetlands may be encroached upon by the development project, but the habitat of a desert animal may be restored, because the particular desert animal having their habitat restored may be in imminent danger of extinction, and/or may have a greater need for restoration of its habitat then the need for restoring wetlands. Mitigation may be conducted by a company encroaching on a habitat with a company development project directly at a proximate site or a more remote site. The mitigation may also be conducted by a third party such that credits are transferred from the mitigating entity to the construction entity in return for some form of compensation.

The mitigation property 102 is a property designated for creation or restoration of a habitat, in response to another habitat being damages or destroyed by a development project. The mitigation property may be any property including, for instance, a location proximate to the construction property, a location remote from the location proximate to the development property, or a habitat similar to the habitat encroached upon by the development property. In an embodiment, mitigation property 102 may initially have a habitat dissimilar to the initial habitat, and then may be converted to a habitat similar to the initial habitat encroached upon. The mitigation property 102 may be owned by, leased to, or be placed under an easement belonging to a mitigating entity, allowing the mitigation company to develop mitigation property 102 into the desired habitat.

The value of a mitigation property 102 may be determined by a number of metrics including, for instance, landscape integrity index, fish faunal intactness index, locations of critically imperiled species, hydrogeomorphic data, and information on high priority conservation sites. The landscape integrity index is used to determine the extent to which a particular mitigation property 102 has already been compromised by development. The fish faunal intactness index is used to determine the suitability of local water sources for sustaining life, with an emphasis on accounting for the effects of local pollutants. A typical metric for the fish faunal intactness index is the extent to which the diversity of species present in a particular geographic location decreases with time, if there is no intervention preventing the decrease in diversity.

The presence of imperiled species metric may include classifications of particular species or ecosystems at risk of destruction. The species may be characterized as imperiled (“G2” or “S2”) and critically imperiled (“G1” or “S1”). One can receive a greater number of credits for creating or restoring habitats for imperiled and critically imperiled species. Also, in order to mitigate for the destruction of the habitat of a particular imperiled or critically imperiled species, the mitigation property 102 may need to provide an alternate habitat for the particular imperiled or critically imperiled species.

Hydrogeomorphic data is data related to the water supply for a particular site. Hydrogeomorphic data represents a reasonable indicator of the habitability of a habitat, because water is typically necessary for life. The water supply to a site may be consistent or may change with time. Watersheds evolve, so it is likely that a parcel will undergo periods of excess and insufficient water supply. Consequently, as part of developing the habitat it may be desirable to create water reservoirs to collect water during dry periods and release the water during wet periods.

It is desirable to find land, for the mitigation properties, that is unlikely to be used by humans for other purposes to decrease the likelihood of the protective status of the land from changing. Mitigation properties are expected by the government to be enduring, but it is often difficult to find tracts of land with no potential for being developed for other human use. Landmasses over which certain governmental protections apply may better serve as mitigation properties 102, because the landmasses under government protection are less likely to be developed. In other words, since the landmass is already difficult to develop for commercial use as a result of other government protections, a commercial developer is less likely to take and interest and lobby the appropriate government officials to make an exception or remove to the government protections. Landmasses over which certain governmental protections apply may include, for example, places deemed culturally important to Native Americans, places protected for environmental reasons, places for which zoning for development cannot be accomplished, and places preserved for nature conservation purposes. For instance, sites of Native American importance are protected from interference and encroachment. Native American remains typically cannot be moved, making Native American burial grounds suitable for establishing an enduring mitigation habitat on a mitigation property 102. Places of cultural importance may also be guarded for purposes of historical conservation and may make suitable sites for mitigation properties, placing signs restricting access, fencing off one or more directions of access, monitoring the condition of the site and repairing damage to the site, when damage occurs, for example.

Many actions may be taken to create, maintain, or restore a mitigation property including, for example, digging, removing earth, adding earth, building enclosures, building cultural structures, diverting water, adding new living species, removing invasive species, and erecting placards with notifications of the existence of a mitigation site. In this specification, when the word species is used it is to be understood as be being generic to both animal and plant species—either of which may be substituted to obtain specific embodiments. The actions employed to create, maintain or restore a mitigation habitat may have to be conducted in a way that respects the purpose of the governmental protections.

For instance, when Native American lands are used, the digging and moving earth may require care in order not to disturb artifacts or remains of Native American cultural importance. It may be that diverting water to a site could damage existing cultural or historical artifacts. Also, the species present at the site may be sufficiently important that the mitigation efforts will have to take care not to disturb the native species. Even the manner in which people act while creating, maintaining or restoring the habitat for mitigation on places of Native American significance may disturb the sensitivities of the tribal members, potentially resulting in revocation of licenses and permits to conduct mitigation activities. The actions and tools necessary to make a mitigation property 102 may differ significantly if the mitigation property 102 is located on a site with governmental protection. For instance, a large tractor to haul dirt would not be an appropriate tool if the site on which the tractor is being used has buried artifacts which may be destroyed by the weight of the tractor. Special permission is required to move Native American remains, and it is immensely difficult to get permission. The enduring nature of the site on which Native American remains are buried may make the site suitable for an enduring mitigation property 102.

The mitigation property 102 may be made on an archaeological site where there used to be remains or items of cultural significance. Alternatively, or additionally, the Native American items may be repatriated to another location. Alternatively, or additionally, the mitigation property 102 may be given the status of nature preserve or wildlife refuge, for example, at the request of the mitigation entity (if the request is granted).

The mitigating entity 104 is an entity that creates and/or restores habitats to mitigate for the effects of development projects. The mitigating entity 104 may be a construction entity responsible for a development project that damaged and/or is expected to damage the environment. Alternatively, the mitigating entity 104 may be an independent entity, for example, conservation or mitigation bank, which transacts in mitigation credits with independent development companies. In an embodiment, the mitigating entity 104 supervises and/or conducts all activities on the mitigation property 102. The mitigating entity 104 may receive funding from the government to restore or create a habitat to mitigate for a publicly funded project that is damaging to the environment. The mitigating entity 104 may reinvest the funding received in a government security, thereby returning the money to the government for use in the form of a government security. The principle of the government security could remain essentially unchanged if the mitigating entity 104 uses only the interest on the government security to establish and maintain the mitigation property 102, affording the mitigation property 102 the capacity to endure, potentially even perpetually. The mitigating entity 104 may sell mitigation credits to a development entity in order to offset the harmful environmental effects of activities conducted by the development entity.

The mitigating entity 104 may apply to the governmental entity to have a particular landmass designated as a mitigation property 102 with a particular mitigation credit value. The value may also be assessed in terms of specific species at risk of losing habitable property to a development project.

The mitigating entity 104 may have a mitigating entity server 106. The mitigating entity server 106 is a system with which electronic data may be processed, received, and transmitted to a network. The mitigating entity server 106 may include non-transitory computer readable media. Each server listed above, (including the mitigating entity server 106) may be a computer system having one or more computers, other computing machines, and/or peripheral machines. Each computer, computing machine and/or peripheral device may have a memory configured to store instructions in the form of data, the instructions to be executed by a processor system.

The mitigation entity server 106 may compute the habitability of a property by computing the property's hygrogeomorphic characteristics, and may compute, which species are likely to be at risk as a result of a public works project. Mitigation entity server may compute the likelihood of survival of a species that is reintroduced to a particular area (the new species may have been native to the area in prior years, but does not currently inhabit that area). The mitigating entity server 106 may transmit data representing funds and/or mitigation credits between, for example, the mitigating entity 104, the development entity, the development entity server, the governmental entity, the governmental entity server, the mitigation entity financial institution, the mitigation entity financial institution server, the development entity financial institution, and the development entity financial institution server. The mitigating entity server may communicate with other servers over a network. The mitigation entity server 106 may store information related to the original state of a habitat prior to being damaged, the damaged state of the habitat, and the health of the habitat after restoration. The mitigation entity server 106 may store records of steps taken to restore or create a habitat.

The development entity 108 is an entity which develops the development property that may be detrimental to a natural habitat and/or encroach upon a natural habitat. The development entity 108 may be the mitigating entity 104 or may be an independent entity. The development entity 108 may mitigate detrimental effects of the development by creating a mitigation property 102. Alternatively, the development entity 108 may offset the detrimental effects of a development by purchasing mitigation credits from a mitigating entity 104 (and the funds are used to create a habitat on mitigation property 102). The government may require the development entity 108 to purchase a particular number of credits and even particular types of credits to offset any damages to habitats encroached upon by a development.

The development entity server 110 is a computer system which processes data representing funds or credits for development entity 108. The development entity server 108 may transmit or receive data representing funds or mitigation credits over a network. The development entity server 110 may transmit data to other servers, via a network. The development entity server 110 may have a processor system and a memory system and may be a computer. The development entity server 110 may include non-transitory computer readable media.

Network 112 may be a network over which communications between mitigation entity server 106, development entity server 110, a government entity server and the financial institutions of mitigation entity 104, development entity 108, and a government entity communicate. Network 112 may include any combination of one or more Wide Area Network (WAN), Local Area Network (LAN), wireless network and/or phone network.

The encroached upon habitat 114 is a habitat which is disturbed by development activity. The encroached upon habitat 114 may be any manner of habitat for which government protection requires mitigation. The encroached upon habitat 114 may be a parcel of land that is particularly valuable ecologically. The encroached upon habitat 114 may have imperiled or critically imperiled species native to the encroached upon habitat 114. The encroached upon habitat 114 may be a nesting ground for critically imperiled species or may be a part of a path of migration for imperiled or critically imperiled species, for example.

The development property 115 is a property on which a development is encroaching upon a habitat. The development property 115 may undergo any kind of development including business, residential, agricultural, and the like. The development activities may destroy elements of a habitat for which a government entity may require certain amount of mitigation. The development property 115 may have similar features to the mitigation property 102, such that the mitigation property can effectively mitigate for the loss of a habitat originally present on the development property 115.

The government entity 116 is any entity of any government and/or of any level of government (e.g., a department and/or office of a government of a country, a territory, state, county, township, city, and/or village). In one embodiment, the governmental entity 116 may be a state or federal government organization dedicated to monitoring endangered species and habitats and may track compliance with mitigation programs. The government entity 116 may require a number of mitigation credits to offset environmentally deleterious effects of a development. To mitigate for the effects of the development on development property 115, the government entity 116 may require a development entity 108 to either purchase or generate mitigation credits on for creating a habitat on a suitable alternative habitat.

In another embodiment, the government entity 116 may be an entity which grants money to create and maintain wildlife habitats. The government entity 116 may grant funds to the mitigating entity 104 for the purpose of restoring or creating a wildlife habitat. The mitigating entity 104 may reinvest the government funds into the government in the form of government securities.

In another embodiment, the government entity 116 may be an entity which issues government securities. The mitigating entity 104 may invest any monies received from the government into government securities. The government entity 108 may pay interest on the government securities to the mitigating entity 104. The mitigating entity 104 may restrain itself and use only the interest received from the government entity 116 to maintain the mitigation property 102 and leave the principle of the government security intact in order to create an enduring mitigation property funded by the interest of the government security. In an alternative embodiment, the mitigating entity may use some of the funds received from the government to initially create or restore the mitigation property 102 and then invest the remainder into the government securities.

The government entity server 118 is a computer system having a processor and memory that are communicatively connected to one another. The government entity server 118 may transmit data representing any of, some of, or all of, funds, demands for mitigation credits, approval for mitigation credits, government security statements, government securities, interest on government securities, for example. The government entity server 118 may be a server for one or many government entities. The government entity server 118 may be a computer with a processor and memory system. The government entity server 118 may include a non-transitory computer readable medium. The government entity server 118 may have any number of computer systems and may represent computer systems of different government entities 116. The government entity server 118 may communicate with a network, such as the Internet.

A mitigation entity financial institution 120, is an entity that receives, sends, and/or holds money for the mitigation entity 104. The mitigation entity financial institution 120 may be, for example, a bank, a fund, and/or a non-profit organization. The transmission of money may occur either physically or electronically. The mitigation entity financial institution 120 may receive money from a government entity 116 or a development entity 108. The mitigation entity financial institution 120 may hold funds for a mitigation entity 104. The mitigation entity 104 may transmit funds to the government entity 116.

A mitigation entity financial institution server 122 is a computer system. The mitigation entity financial institution server 122 may be a computer, a number of computers, a server, a processor and memory system, a non-transitory computer readable medium, and a portable device, for example. The mitigation entity financial institution server 122 may receive money from the development entity 108, the development entity financial institution, the development entity financial institution server, and the government entity 116, for example. The mitigation entity financial institution server 122 may send money to the government entity 116, for example. The mitigation entity financial institution 120 may hold money for the mitigation entity 104 with records in the mitigation entity financial institution server 122. The mitigation entity financial institution 120 may conduct financial transactions using funds held in the mitigation entity financial institution 120.

A development financial institution 124 is an entity that receives, sends, or holds money for the development entity 108. The development financial institution 124 may transmit money to the mitigation entity 104 or the mitigation entity financial institution 120. The development financial institution 124 may hold funds for the development entity 108, in order to allow the development entity 108 to transact financial transactions.

A development financial institution server 126 is a computer system. The development financial institution server 126 may have a number of computers with processor systems and memory systems, and/or non-transitory computer readable media, for example. The development financial institution server 126 may be used by the development entity financial institution to transmit funds on behalf of the development entity 108, for instance, to a mitigation entity 104 in exchange for mitigation credits.

A government financial institution 128 is an entity that receives, sends, or holds money for government entity 116. The government financial institution 128 may transmit money to the mitigation entity 104 or the mitigation entity financial institution 120. The government financial institution 128 may hold funds for the government entity 116, in order to allow the government entity 116 to transact financial transactions.

A government entity financial institution server 130 is a computer system that may include any number of computers, having processor systems, and memory systems with non-transitory computer readable media, for example. The government entity financial institution server 130 may be used by the development entity financial institution to transmit funds on behalf of the government entity 116, for instance, to a mitigation entity 104 in exchange for mitigation credits.

Database 132 stores records of sites, artifacts, and/or remains that need to be treated with respect. The records may include an identification, description, location, and instructions related to treatment of the sites, artifacts, and/or remains. The records may also include entries for contact information for the organizations (e.g., the Native American tribes and/or government agencies) that have a say in the treatment of the sites, artifacts, and/or remains. The sites, artifacts, and remains may include sites, artifacts, and remains that are important to Native Americans, and/or sites, artifacts, and remains that are important for archeological reasons, and/or historic reasons. Database 132 may also include agreements with interested parties about how to treat the sites, artifacts, and/or remains and/or steps taken to ensure the safety of the sites, artifacts, and remains or to avoid disrespecting of the sites, artifacts, and remains.

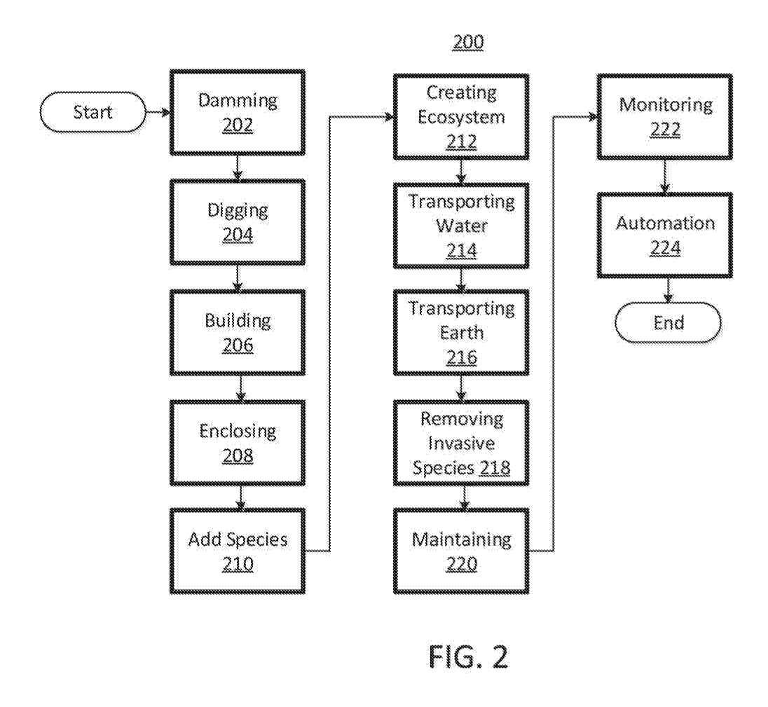

FIG. 2 shows a block diagram of an embodiment of a system of activities and structures used to create a mitigation habitat. The system may include, for example, establishing water control structures 202, digging 204, building 206, enclosing 208, adding species 210, creating or reestablishing an ecosystem 212, transporting water 214, transporting earth 216, removing invasive species 218, maintaining 220, monitoring 222, and automation 224.

Establishing water control structure 202 may include building dams, flood gates, risers, and/or other water control structures that control the manner in which a water source flows. As part of controlling the water flow, dam or other water control structure may be erected from building materials such as concrete, metal, earth, and polymers, for example. The water control structure may be above ground or below ground. Damming and other water control structures may affect the watershed of a local habitat and may make the habitat more habitable for a particular species, for instance an imperiled or critically imperiled species. The water control structure may completely or partially stop the flow of water through a particular region and may merely establish a reserve of water that did not exist previously. Establishing water control structures 202 may require digging up dirt, moving dirt, pouring cement, placing a metal or polymeric dam, burying, placing stakes in the ground or collapsing a mound of dirt into a water stream, for example. Establishing water control structures 202 may include first, temporarily diverting water from the river so as to dry up the river in the region where it is desired to place the dam. Then the foundation of the dam may be laid, which may include laying down rocks, or cement, for example. Next, more material (e.g., rocks, wood, steel, cement) is added to until the dam is at the correct height. Then, the material is reinforced with more material further upstream. Optionally, the structure may be covered with cement. The dam may include locks for releasing water and/or a turbine for generating power. Then canals dug to divert the water are filled in, so that the river returns to the original river bed, while being blocked from the dam.

Digging 204 is the act of removing earth from the ground. The digging 204 may occur entirely above ground or below ground. Digging 204 can be used to create a physical barrier or can be used to create waterways. Digging 204 may also be appropriate to create caverns or troughs to facilitate nesting. The digging 204 may also be used to remove a top level of soil inappropriate for particular species of plants which may be part of an ecosystem a mitigation entity 104 creates or reestablishes. Digging 204 may also be used to lay foundations for structures including physical barriers, cultural buildings, and even decorative art, for example. The digging 204 may be done especially carefully to avoid Native American remains or artifacts by digging around the remains or artifacts. One may use any number of tools to perform the digging, including, for example, using a tractor, a plow, a shovel, a tiller, a post digger, a hoe, and a back-hoe, which may be used to perform any of the digging in this specification.

Building 206 is erecting structures. Building 206 may involve building cultural structures. Building 206 cultural structures may involve, for example, laying a foundation, fastening building materials, adding aesthetic features, building stairs or elevators. Building may also involve building water storage areas, such as cisterns, water towers, ponds, or springs to assure a prolonged water supply in a habitat where water depletes too quickly. Additionally, or alternatively, building 206 may involve building enclosures, such as fences or walls.

Enclosing 208 is creating physical barriers around an area. Enclosing may include, for example, erecting a fence, erecting a wall, creating a mound of dirt around an area, placing a sign signaling to passersby that people should not enter, or locking entryways with a lock. The enclosing 208 can have a number of purposes including, for example, preventing human traffic, preventing animal traffic, preventing the invasion of invasive species, and limiting runoff from the watershed.

Adding species 210 is the act of taking a species from a habitat and placing the species in another habitat. The species added may be imperiled or critically imperiled such that creating or reestablishing a habitat can earn an entity mitigating credits with respect to the imperiled or critically imperiled species. Adding species 210 may be done by transporting the species itself and/or by transporting elements of the species' environment. For instance, in order to transport a species of mussel, one may transport the substrate to which the mussels may be attached. One may attempt to merely adjust the migratory path of a species to allow nesting or simple watering in order to add species 210, such as by adding features that a particular species is attracted to. For example, bodies of water may be added to attract water fowl, fish, and/or other animals in need of water. Various plants may be plated that are known to attract particular insects or animals. For example, trees may be planted to provided nesting areas for birds and/or shelter for wild animals. Adding species may require cages for transporting land animals or tanks for transporting sea animals, for example, and vehicles for moving the cages and/or tanks.

Creating or reestablishing an ecosystem 212 is an act of establishing an environment in which species and environmental elements interact in a synergistic manner to promote the life and/or reproduction of the species. The creating or reestablishing an ecosystem 212 may involve creating an entirely new ecosystem that has yet to exist in a location. This ecosystem may be particularly suited to an imperiled or a critically imperiled species. While one may create an ecosystem from scratch, one may also recreate a habitat that was formerly present in a location. For instance, one may restore a water supply to a location from which water was diverted to create a renewed watershed to promote life. One may also reestablish species in an environment in which the species have left. One may deposit complimentary species necessary to establish an ecosystem for imperiled or critically imperiled species, the complimentary species perhaps not being imperiled but fostering the health of imperiled or critically imperiled species populations.

Transporting water 214 is the act of bringing water to an environment to promote life requiring greater quantities of water than the current watershed provides. Transporting water may be accomplished by digging 204 for underground reservoirs or damming 202 a river to create a reservoir. Transporting water may also be done by removing water from one location and transporting the water to another site by pipes or in tanks on boats, trucks, planes, and/or trains. Transporting water 214 may be accomplished by loading water into a truck and transporting the water. Transporting water 214 also may be accomplished by adding water to a water tower located onsite to store the water for later use.

Transporting earth 216 is the act of taking earth from one location and placing the earth in another location. One may transport earth 216 with various nutritional elements for plant and animal species in order to create a nutritional environment conducive to population growth of a particular species. The transporting earth 216 may also be to prevent the spread of invasive species by transporting earth 216 with elements not conducive to the health or desires of an invasive species. Transporting earth 216 may transport earth that may be used as the material for building a dam or for changing the landscape by adding or removing hills and mountains to promote a particular type of habitat. Transporting earth 216 may involve digging 204 to remove the earth from one location and place the earth in another location.

Removing invasive species 218 is the taking of an invasive species from a habitat. Invasive species may be a predator of a desired species or may compete with the desired species for nourishment. Removing invasive species 218 may involve, for example, physically removing the invasive species (e.g., by trapping individual animals of the species and moving the animals trapped to a new location or by chasing the invasive species out of the area of interest or uprooting invasive plants), exterminating the invasive species, selectively treating the invasive species with growth or reproduction inhibiting substances, introducing a species that competes with the invasive species for nourishment, or introducing a predator of an invasive species. Also, predators of the invasive species may be introduced to the property. For instance, mitigation property administrators may allow grazing on the land in order to cull invasive plant species. Removing invasive species 218 may involve digging 204 to capture invasive insects or animals that live in the ground or uproot invasive plants and the seeds from the invasive plants.

Maintaining 220 is maintaining a habitat. Maintaining 220 is not necessarily a passive process. Maintaining 220 may involve repeating steps taken to create a habitat. Maintaining 220 may also require further actions, including, for example, building and barrier maintenance, watershed maintenance by directing water flow, monitoring the spread of invasive species perhaps by culling, determining whether the habitat continues to be viable for a particular purpose, or increasing an element of an ecosystem. Maintaining may involve monitoring the amount of moisture in the soil and/or the amount of water in a reservoir or the water shed and automatically adjusting the water flow brining water into or out of the property. In response to the monitoring, the amount of water may be automatically adjusted by altering the degree to which a gate is closed or open in a dam holding water in a reservoir, adjusting a valve in a pipe bring water into or out of the habitat. Maintaining 220 may also involve grazing domesticated or Ferrell animals on the mitigation property. Maintaining 220 may include repairing structures that fall into disrepair, such as the repairing walkways, nesting structures, fences, and/or repairing water control structures, such as gates, flashboards, and/or risers.

Monitoring 222 is monitoring the effectiveness of the habitat after the habitat is created. The monitoring 222 may not necessarily be a passive process. Some elements of monitoring 222 may be accomplished in an automated fashion, for instance, monitoring the humidity and watershed levels as well as temperature and potentially even foot traffic. The monitoring 222 may also involve cameras and/or other sensors detecting and such as counting the number of a particular species that is present in a habitat or passes through a habitat, determining the effectiveness of the different players in a particular ecosystem, determining the effectiveness of physical barriers in preventing people or invasive species from entering, and determining whether the conditions created for the habitat are sufficient to allow the habitat to endure. If the conditions created are not sufficient, then a determination may need to be made as to what actions need to be taken to create conditions sufficient for the habitat to endure.

Automation 224 is the act of setting up and/or operating a device to control and monitor the habitat or at least an element of habitat. Automation may use a computer with a processor configured to execute instructions stored in a memory having one or more non-transient computer readable media. Processes which may be automated may include monitoring the environmental conditions of a habitat, including, for example, water levels, humidity levels, temperature levels, foot traffic, animals present in the habitat, animals passing through the habitat, and barometric pressure. Automation 224 may include automatically opening, closing, partially opening, and/or partially closing a flood gate or riser to automatically adjust the level of water of a reservoir and/or the amount of water in a water shed. Automation 224 may include automatically turning on a sprinkler to keep certain species moist and/or spraying insecticides or herbicides. Automation may include automatically making detecting the need for certain repairs, such as patching a hole in a fence, a building, or a dam. Automation may include automatically cleaning a building associated with the habitat.

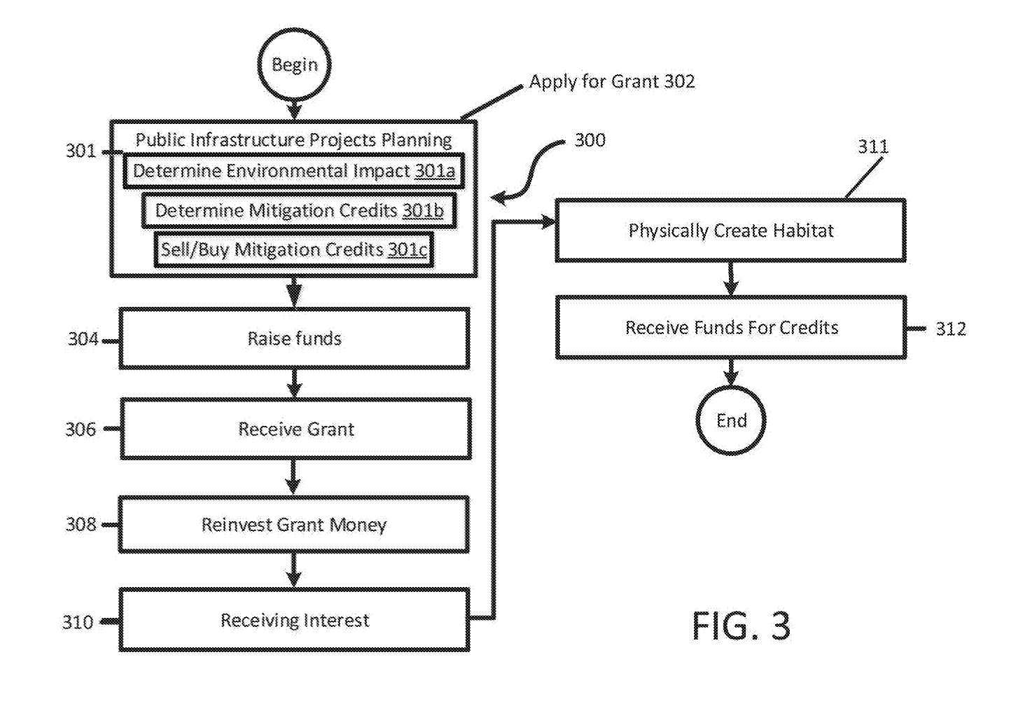

FIG. 3 shows a flowchart of an embodiment of a method for creating a mitigation property from the perspective of a mitigating entity. The method 300 may include steps of applying for a government grant 302, receiving funds from the government grant 304, reinvesting the funds received from the government grant in a government security 308, receiving interest earned on the government security 310, physically create and maintain a mitigation habitat using interest earned on the government security 311, receive funds from a development entity for mitigation credits 312.

Public infrastructure planning 301 may include planning and/or building a public infrastructure project. Public infrastructure project may include building a publically accessible structure that is needed and/or highly desirable for a modern day society, such as bridges, roads, dams, telephone wire, rail road tracks, roads, sidewalks, highways, tunnels, public schools, water pipes for a public water system, government office buildings, airports, train stations, bus stations. Public infrastructure planning 301 may include substeps 301a, 301b, and 301c. Substep 301a may include performing environmental studies to determine the impact that the public infrastructure project is expected to have on the environment. Substep 301a may include determining the impact the archeological interest, historic interest, and/or Native American interests of the site. Substep 301a may include automatically monitoring the site to determine the species present in the habitat and characteristics of the habitat. The information about the species present and other information about the site at which the public infrastructure will be built may input into a database.

In sub-step 301b, the number of mitigation credits that need to be purchased as a result of the public infrastructure project are determined. In an embodiment the mitigation credits are determined automatically based on input from public infrastructure planning 301.

In step 301c, mitigation entity sells mitigation credits to the entity building the public infra structure.

Applying for a government grant 302 is a process by which rights are requested for developing a particular habitat for mitigation. The rights may include an easement for accessing and developing the property. Proceeds from the mitigation credits sold may be used for funding the development of the mitigation property. Applying for a government grant 302 may also involve requesting funding from the government for developing the mitigation property into a habitat, in addition to or instead of the revenue generated from selling mitigation credits. In an alternative embodiment, the grant for funding and/or rights is for developing a multiuse property. Uses of the multiuse property may include establishing a cultural center, a mitigation habitat, a wildlife refuge, a park, a government protected park, an educational park, a Native American cultural site, and/or a government recognized park, for example. A government entity may be more apt to fund a project for purposes greater than merely mitigation (e.g., having multiple uses). In an embodiment, step 302, includes filling out an online form (or a paper form) and submitting the form via mitigation entity server 106 to government entity server 118. Government entity server 118 may automatically process the application and automatically approve or deny the application. Optionally or alternatively, government entity server 118 may also receive input from one or more reviewers that review the application and indicate to government entity server 118 whether to approve or deny the application.

In an embodiment, the receiving funds or rights from the government grant 304 may include receiving rights and/or funds associated with a grant from the government and/or receiving funds from the sale of mitigation credits. The receiving of funds from the government grant 304 may involve a mitigation entity financial institution 120 in that the funds may be received by the financial institution as an agent of the mitigation entity. In an embodiment, funds that were sent from government entity server 118 or a server of government entity financial institution may be received at mitigation entity financial institution server 122 at an account of the mitigation entity on behalf of the mitigation entity 104. Additionally, development entity server 110 may send a message to development financial institution server 126 to transfer funds to mitigation entity financial institution server 122 on behalf of mitigation entity 104 as payment for the mitigation credits. Mitigation server 106 may send an electronic form of the mitigation credits to development entity server 110.

Reinvesting the grant funds in a government security 308 may include taking money received from a grant and reinvesting the money from the grant in a government security. The government security may be any interest bearing government financial instrument. Mitigation Entity server 106 may send a signal to mitigation entity financial institution server 122 to send funds to government entity server 118 or government entity financial institution server 130 for purchasing a security. For instance, the security may be in the form of government bonds. The funds may be transmitted by a mitigation entity financial institution server 122 (as an agent of a mitigation entity) to a government entity server 118 or to a server of a financial institution of the government entity 116. Government entity server 118 may then send an electronic form of the security to mitigation entity server 106.

Receiving interest earned on the government security 310, may include receiving funds that result from interest from the government entity. The interest received may be received at a financial institution (by a mitigation entity financial institution server 122) acting as a financial agent for the mitigating entity 104. The mitigation entity financial institution 120 may hold the funds for the mitigation entity 104 and may even pay interest on the funds received from the government entity 116, via government entity financial institution server 130. In an embodiment, all of the funds received are invested in the government security and the mitigation habitat is completely funded from revenue from the security. In an alternative embodiment, a portion of the funds received are used for creating the habitat, and the remainder of the funds is invested in the government security, so that the interest from the security funds the maintenance of the habitat.

Physically creating and maintaining a mitigation habitat using interest earned on the government security 311 may include conducting physical actions using the funds earned as a result of interest on a government security. The physical actions may include, for example, any of the activities used to create a mitigation habitat in the embodiment described in FIG. 2, including, for example, damming 202, digging 204, building 206, enclosing 208, adding species 210, creating or reestablishing an ecosystem 212, transporting water 214, transporting earth 216, removing invasive species 218, maintaining 220, monitoring 222, and automation 224.

Receiving funds from a development entity for mitigation credits 312 is a transaction between a mitigating entity 104 and a development entity 108 for the mitigating entity 104 to transmit mitigation credits to the development entity in exchange for funds from the development entity. In an embodiment, step 312 may include development financial institution server 126 sending funds from an account of the development entity 108 over the Internet to mitigation entity financial institution server 122, which are automatically credited (by mitigation entity financial institution server 122) to an account of mitigation entity 104. In an embodiment, in exchange for the funds, mitigation entity server 106 may send an indication to government entity server 118 to credit development entity 108 with an appropriate amount of mitigation credits. Then, government entity server 118 and/or mitigation entity server 106 may send to development entity server 110 an indication that development entity 108 has been credited with an appropriate amount of mitigation credits. The funds received from the development entity may be used to help maintain and/or establish the habitat. The funds may be received prior to purchasing the government security and used for funding the government security.

In an embodiment, each of the steps of the method shown in FIG. 3 is a distinct step. In another embodiment, although depicted as distinct steps in FIG. 3, steps 302-312 may not be distinct steps. In other embodiments, the method shown in FIG. 3 may not have all of the above steps and/or may have other steps in addition to or instead of those listed above. The steps of the method shown in FIG. 3 may be performed in another order. Subsets of the steps listed above as part of the method shown in FIG. 3 may be used to form their own method.

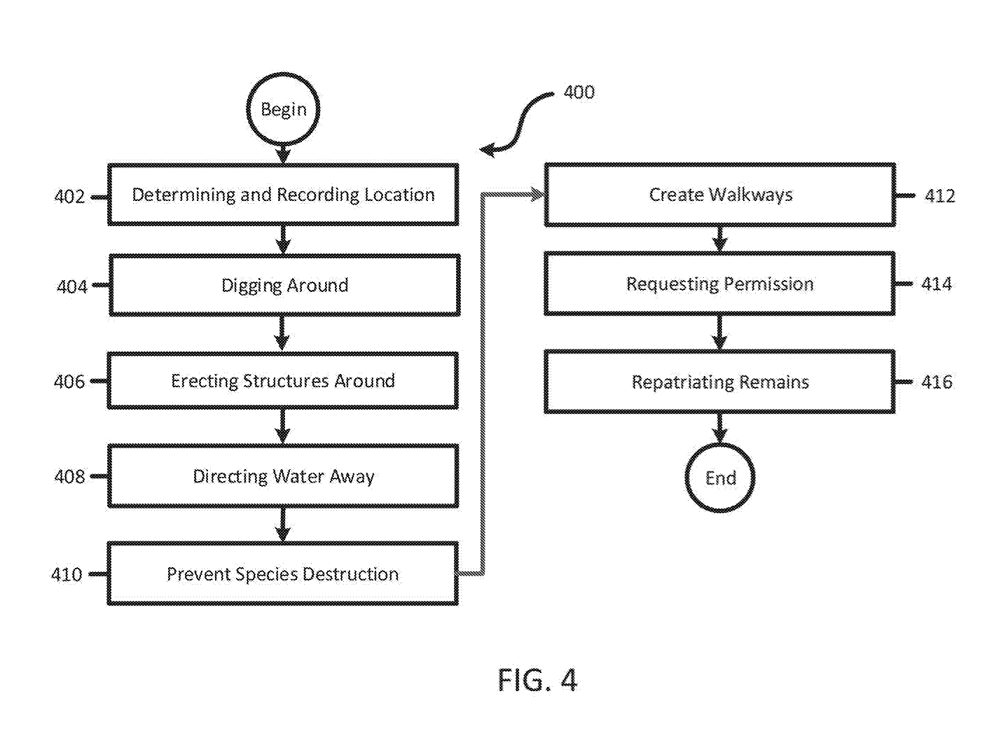

FIG. 4 shows a flowchart of an embodiment of a method for creating a mitigation property on Native American lands from the perspective of a mitigating entity 104. The method may includes steps of determining the location of Native American artifacts or remains 402, digging around Native American artifacts or remains 404, erecting structures in places that will not harm Native American remains or artifacts 406, directing water away from Native American remains or artifacts 408, prevent destruction of species important to Native American traditions 410, creating walkways to prevent treading upon Native American remains or artifacts 412, requesting permission from the Native Americans to conduct activities 414, and repatriating remains or cultural artifacts 416.

Determining the location of Native American artifacts or remains 402 may be done by historical record or may be conducted by computerized imaging technology which can determine shapes of buried items. The determination of the location of the Native American artifacts may be determined using a magnetometer, electrical resistance meters, ground-penetrating radar (GPR), and/or electromagnetic (EM) conductivity meters.

The electrical resistance meter, similar to an ohmmeter, measures resistance. Metal probes may be inserted into the ground and the local electrical resistance between the probes is measured. In one embodiment, four probes are attached to a rigid frame and the conductivity between the probes is measured. Regions having higher or lower resistivity than their surroundings may contain bones or other artifacts related to sites significant to Native Americans. For example, a stone foundation may impede the flow of electricity, while the organic deposits, such as bones, may conduct electricity more easily than surrounding soils. The electrical resistance meter may produce a plan view map, and may produce a limited vertical profile.

Electromagnetic (EM) conductivity may detect Native American Artifacts by applying an electric current of a predetermined frequency and magnitude through a first coil to generate a magnetic field underground. The fluctuating magnetic field stimulates a secondary current in conductive or semi-conductive materials that is in and/or makes up the ground, which in turn creates a secondary magnetic field that is picked up by a receiving coil. Spatial changes in the underground conductivity alter the secondary magnetic field received at the second coil (when compared to what the secondary magnetic field would have been had the conductivity been uniform), which can indicate the presence of Native American burial sites and/or other significant Native American artifacts. One advantage of electromagnetic sensors is that electromagnetic sensors do not require direct contact with the ground, and can be used in conditions unfavorable to resistance meters. Another advantage is relatively greater speed at which measurements can be made than resistance instruments. In an embodiment, EM conductivity instruments are also capable of measuring magnetic susceptibility. On the other hand, electrical resistance meters tend to be more sensitive than electromagnetic conductivity meters.

The magnetometer may include one or more signal sensors that measure the total magnetic field strength at the location of interest. When multiple sensors are used, the sensors may be spatially separated, and the gradient of the magnetic field may be measured (by measuring the difference between magnetic fields at the sensors). Using the gradient configuration (which may be called the gradiometer configuration) better resolution of small, near-surface bones and artifacts can be determined. In an embodiment, the magnetometer may include a fluxgate. Every kind of material, such as bones and other materials in Native American artifacts has unique magnetic properties. Different materials below the ground can cause local disturbances in the Earth's magnetic field that are detectable with the magnetometer (if the magnetometer is sensitive enough). It is often possible to detect very subtle anomalies caused by disturbed soils or decayed organic materials with the magnetometer.

Ground-penetrating radar (GPR) generates the radar signal (an electromagnetic pulse), which is directed into the ground. Bone and other Native American artifacts below the ground will cause reflections that are picked up by a receiver. The travel time of the reflected signal indicates the depth of the item reflecting the signal. The GPR data may be plotted to produce profiles of the items detected and/or produce plan view maps isolating specific depths. GPR can be more useful in certain conditions (uniform sandy soils are ideal). The GPR detects spatially small objects at relatively great depths, while indicating the depth of the items causing the reflections. However, in areas that have less-than-ideal conditions for GPR or when time does not permit, one of the other instruments may be used.

In an embodiment, taking measurements involves walking with the instrument(s) of choice (the GPR, magnetometer, conductivity meter, and/or resistance meter, for example) along closely spaced parallel paths, taking readings at regular intervals. In an embodiment, the area to be surveyed is divided into a series of rectangular (e.g., square) regions. The corners of the grids are used as reference points. The instrument operator may lay down tapes or marked ropes, to reduce or minimize positioning errors, which may be used to keep the positioning errors to within a few centimeters. In an embodiment, a global positioning systems (GPS) is integrated in the magnetometer, the electrical resistance meter, the GPR and/or the electromagnetic conductivity meter. The magnetometer, the electrical resistance meter, the GPR and/or the electromagnetic conductivity meter may determine the GPS coordinates of the artifacts based on the GPS coordinates of the instrument and the measurements of the location of the artifacts. A metal detector may also be used for less formally scanning areas of interest.

The data gathered may be stored in a computer, optionally in a database. The data may be processed, by the computer, by removing data points that are statistical outliers, removing noise, and/or interpolating between data points to determine likely values of data at locations where data was not measured. Statistical filters may be designed to enhance features of interest (based on size, strength, orientation, or other criteria), or suppress obscuring modern or natural phenomena. Inverse modeling of features, may be used for determining the likelihood that the site has significance as Native American burial site or other Native American significant site. Inverse modeling refers to building a model of features of the item of interest based on what features would likely generate the pattern of measurements recorded. The processed data may be rendered as images, as contour maps, and/or in a false relief, and presented to the user (a false relief is an image that appears to have depth (e.g., made by a series of triangles), but is just a two dimensional image.

The images produced form the data measured by the magnetometer, electrical resistance meters, ground-penetrating radar (GPR), and/or electromagnetic (EM) conductivity meters may be instrumental in determining how to create a mitigation habitat on Native American lands in order to respect Native American and United States laws and sensibilities. It may be difficult to remove Native American remains in a way that can be agreed upon by Native American authorities or even U.S. government authorities, so a mitigating entity may be required to conduct mitigation activities in a way that does not disturb Native American remains or cultural artifacts.

In step 404, a hole or trench is dug for the foundation of the building, fence, other structure, for a water reservoir (e.g., a pond or lake), to direct water to a pond or reservoir, and/or to create a canal for bringing water through the habitat. In step 404, the digging is performed while consciously avoiding disturbing Native American artifacts or remains. Based on the map of the location produced in step 402, the map the location of the artifacts and of the remains may be consulted to determine where the artifacts or remains are not located and then any digging that may be performed may be in the locations that the artifacts are not located.

In step 406, structures are erected, such as a building for displaying exhibits about the site, water control structures, and/or fences in places that will not harm Native American remains or artifacts at the site. Step 406 may include erecting buildings, fences, and/or water control structures, (or other structures) in areas where Native American remains or artifacts will not be disturbed. The erecting of step 406 may be conducted in a way that underground items are not affected, may be conducted away from the underground items. The structures built may be those that promote the value of the underground items. For instance, the building may include unearthed artifacts exposed from the ground and/or a replica of the items that are expected to be located underground. The building may include exhibits that convey the story behind the significance of the site. The erecting 406 may involve heavy materials which may damage any underground remains or cultural artifacts, so the erecting 406 may have to be conducted elsewhere on the Native American lands. Also, even if the Native American remains or cultural artifacts would not be harmed by the erecting 406, Native Americans may find it offensive to build a structure over Native American remains or cultural items.

In step 408, structures for collecting and/or directing water may be constructed to control the amount of water in the habitat. In step 408, the water is directed away from Native American remains or artifacts 408, by diverting water from areas where water can cause damage to remains or cultural artifacts. Water may erode or chemically alter preserved artifacts or remains. Directing 408 may prevent destruction of Native American artifacts or remains. If the property had water that flows over Native American remains, the water may be directed away from the Native American remains.

Ensuring the presence of species important to Native American traditions 410 may include reintroducing species and/or habitats of species important to Native Americans. Step 410 may include preventing the destruction of species and/or habitats of species that are important to Native Americans. Step 410 limits the removal of species or habitats of species that are essential to rituals of local Native Americans on Native American land. For instance, a wolf may be an invasive species for a particular imperiled species, but preventing the wolf from entering the Native American lands may disturb an outlet for service of a deity or spiritual activity. As such, one may consider whether a site is appropriate for a mitigation property with respect to a particular imperiled or critically imperiled species.

In step 412, walkways and/or other structures are created to prevent treading upon Native American remains or artifacts or encourage visitors to walk in areas that have no Native remains, which may include designating areas for human traffic to prevent harm to Native American cultural artifacts or remains. For instance, one may pave a path around items of Native American significance. Creating walkways may involve laying stones, pouring cement, or tar and gravel in the region intended to be the walkway. In an embodiment, a sidewalk may be paved in order to discourage foot traffic over remains or cultural artifacts. Also, signage can be provided to inform visitors or construction personnel that failing to tread carefully along designated walkways could disturb Native American cultural remains or artifacts and draw the ire of the local Native American population and perhaps destroy a valuable piece of history.

In step 414, permission is requested from the Native Americans to conduct activities. Step 414 may include approaching the local Native American governing body to receive permission for any activities conducted on the Native American land. One may address the governing body with a plan for a mitigation project and delineate the measures to be taken to avoid disturbing or harming Native American cultural artifacts, remains or even the way of life of the local Native American populations. In an embodiment, the local Native American governing body may have a website and form that is filled out for contacting and making requests from the Native American governing body. An incentive may be offered to the governing body with to employ members of the Native American population in the mitigation project.

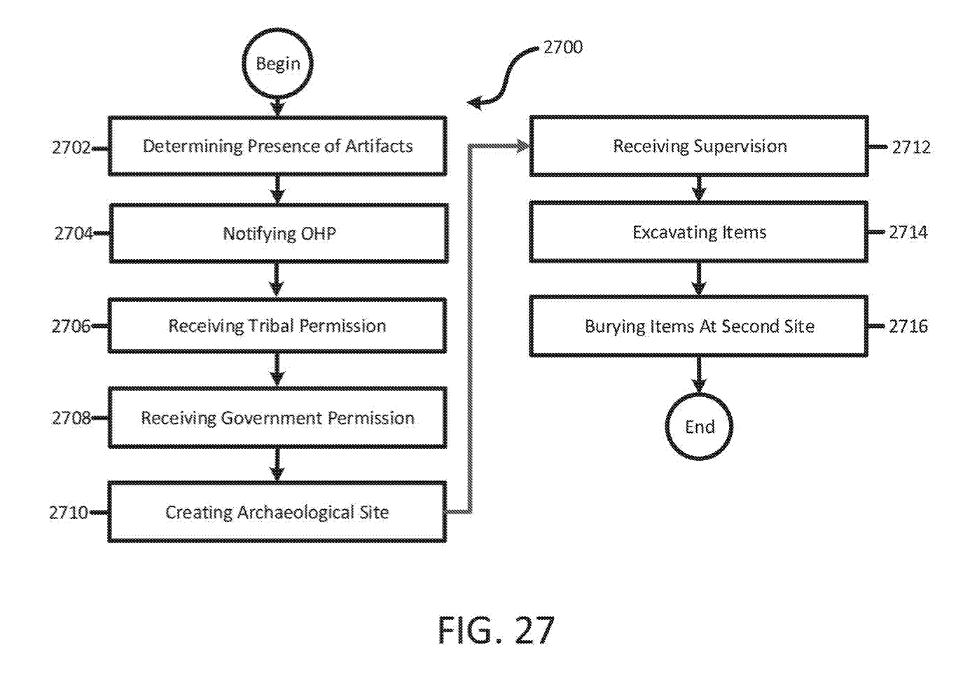

Repatriating remains or cultural artifacts 416 is removing Native American artifacts and remains from one location to another location. Repatriating remains may require legal permission from a number of entities. An embodiment of a method for repatriating remains is discussed in FIG. 27. Repatriating may include moving remains and/or cultural artifacts from another locations and moving remains and/or cultural artifacts to the habitat, thereby creating a site that is significant to Native Americans. The repatriating of the remains may include various ceremonies to ensure that the remains are treated with proper respect and reverence according to the Native American community associated with the remains. For example, the ceremony may include smudging, which may involve the burning of incense, such as common sage, lavender, desert sage (Artemisia Tridentata), white sage (Salvia Apiana), lakota sage (Artemisia Vulgaris), sweetgrass (Heirochloe Odorata), cedar (Cedrus Atlantica), juniper (Juniperus Communis), bear root or osha (Ligisticum porter), willow bark (Salix), Tobacco (Nicotiana Tabacum), corn (Zea Mays) blue, white, red, or yellow, Star Anise (Illicium Verum), pinon resin (Pinus Edulis), copal resin (Bursera Microphylla), black, golden, or white (found in Mexico), frankincense resin (Boswellia Carteri) (found in North Africa), myrrh resin (Commiphora Myrrh) (found in North Africa), dragon's blood resin (Croton Lechleri), (cound int South American rain forest), and/or palo santo (Bursera Graveolens) (found in Peru), and/or other herbs, for example. The ceremony may be accompanied by directing the smoke with a smudging feather, which is a bird's feather. The smoke may be directed at the remains, the location where the remains will be placed and/or the location where the remains were taken from. Optionally, an offering of tobacco may be made, which may entail smoking the tobacco in a ceremonial pipe. When using sweet grass, the sweet grass may be braided together, optionally in three strands. The incense may be burnt in a clay bowl or abalone shell, for example. Alternatively, or additionally, the incense may be wrapped together in stick, which may be waived over and/or around the remains and/or the new grave site. The burning of the incense may include lighting the incense and then extinguishing the fire so as to allow to the herbs to smolder.

In an embodiment, each of the steps of the method shown in FIG. 4 is a distinct step. In another embodiment, although depicted as distinct steps in FIG. 4, steps 402-416 may not be distinct steps. In other embodiments, the method shown in FIG. 4 may not have all of the above steps and/or may have other steps in addition to or instead of those listed above. The steps of the method shown in FIG. 4 may be performed in another order. Sub-sets of the steps listed above as part of the method shown in FIG. 4 may be used to form their own method.

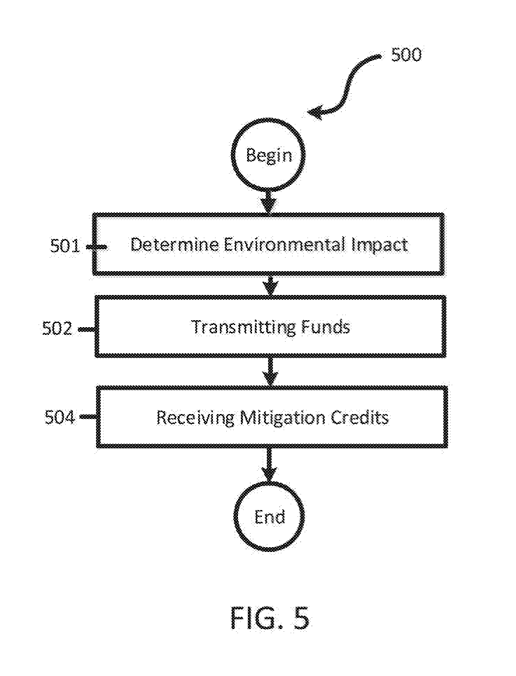

FIG. 5 shows a flowchart of an embodiment of a method for creating a mitigation property from the perspective of a constructing entity. In optional step 501, the constructing entity determines the environmental impact of the public infrastructure. The method may include the steps of transmitting funds to a mitigating entity 502, and receiving mitigation credits from a mitigating entity 504.

Transmitting funds to a mitigating entity 502 may include transmitting money to a mitigating entity. The development entity may transmit funds directly to the mitigation entity or the transfer may occur electronically via servers with processors and memory systems of financial institutions. The development entity may have a financial institution acting as an agent to transfer funds to a financial institution of a mitigating entity. For example, development entity server 110 may send a signal to development financial institution server 126 to send funds to mitigation entity financial institution server 122, which accepts the funds on behalf of mitigation entity 102. In return mitigation server 106 sends mitigation credits to development entity server 110. Alternatively, the transaction may be conducted physically via cash or check or may be conducted entirely electronically via other means.

Receiving mitigation credits from a mitigating entity 504 may include receiving mitigation credits, electronically, to offset any environmental effects of a development conducted by a development entity. The mitigation credits may be specific to an imperiled or a critically imperiled species. The mitigation credits may be received from mitigation entity server 106 by the development entity 108 at development entity server 110, as a result of the habitat restoration of mitigation entity 104.

In an embodiment, each of the steps of the method shown in FIG. 5 is a distinct step. In another embodiment, although depicted as distinct steps in FIG. 5, steps 502-504 may not be distinct steps. In other embodiments, the method shown in FIG. 5 may not have all of the above steps and/or may have other steps in addition to or instead of those listed above. The steps of the method shown in FIG. 5 may be performed in another order. Subsets of the steps listed above as part of the method shown in FIG. 5 may be used to form their own method.

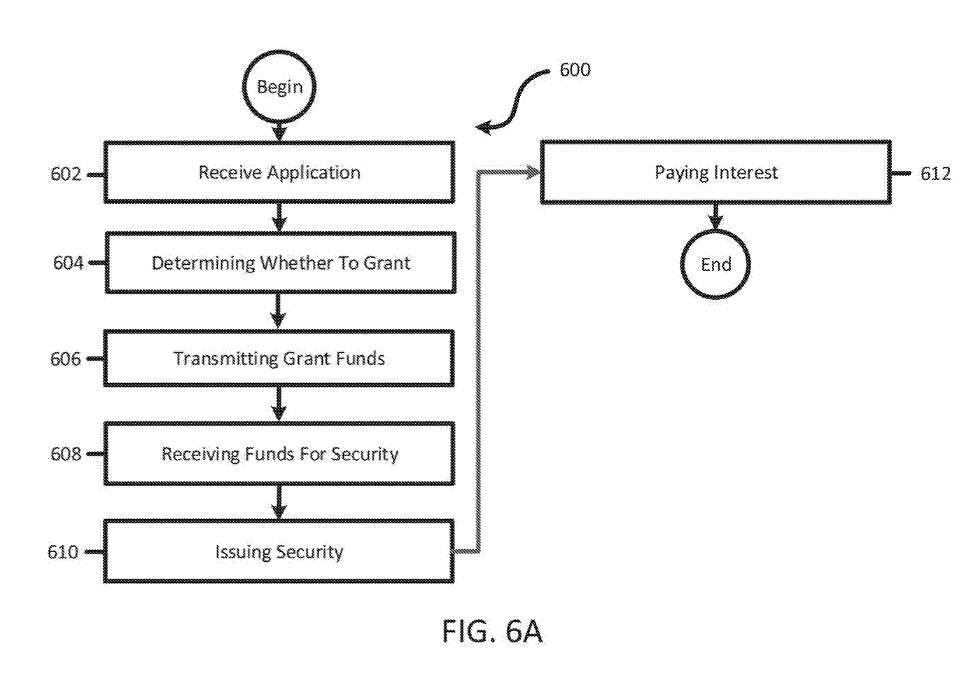

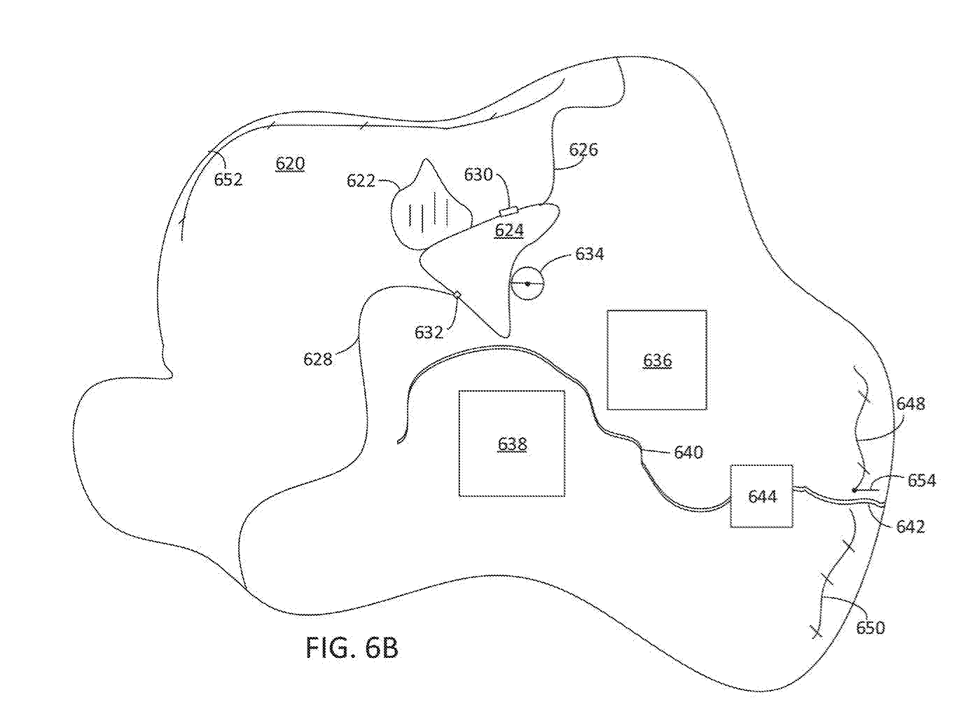

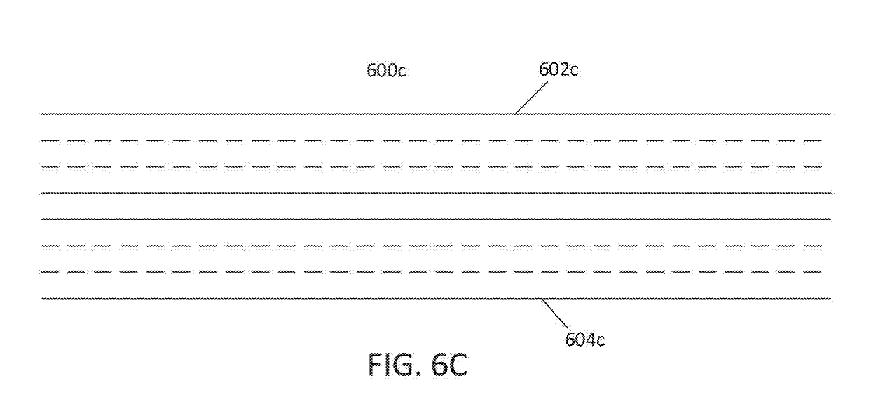

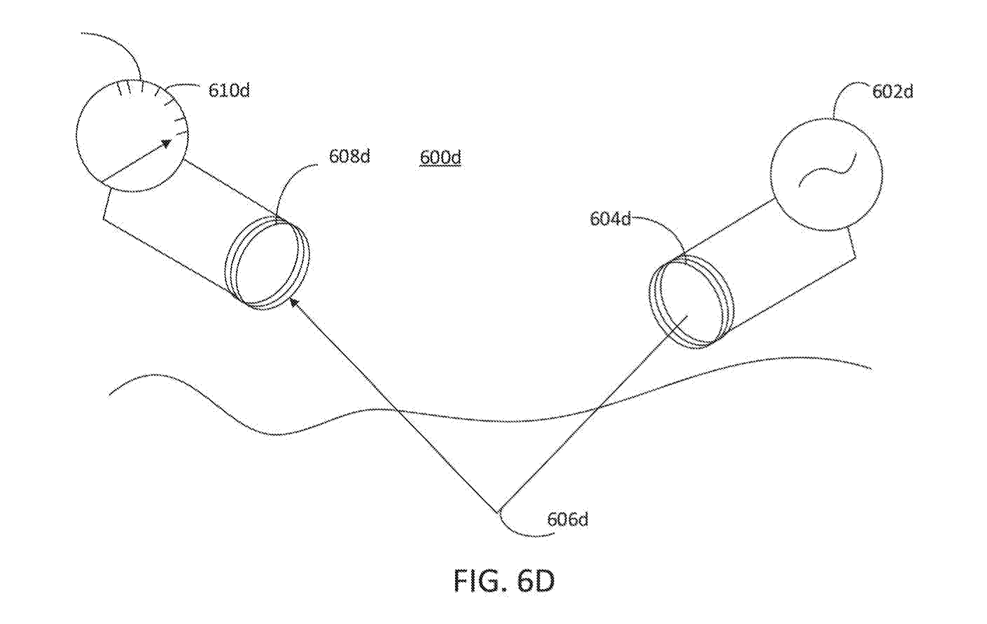

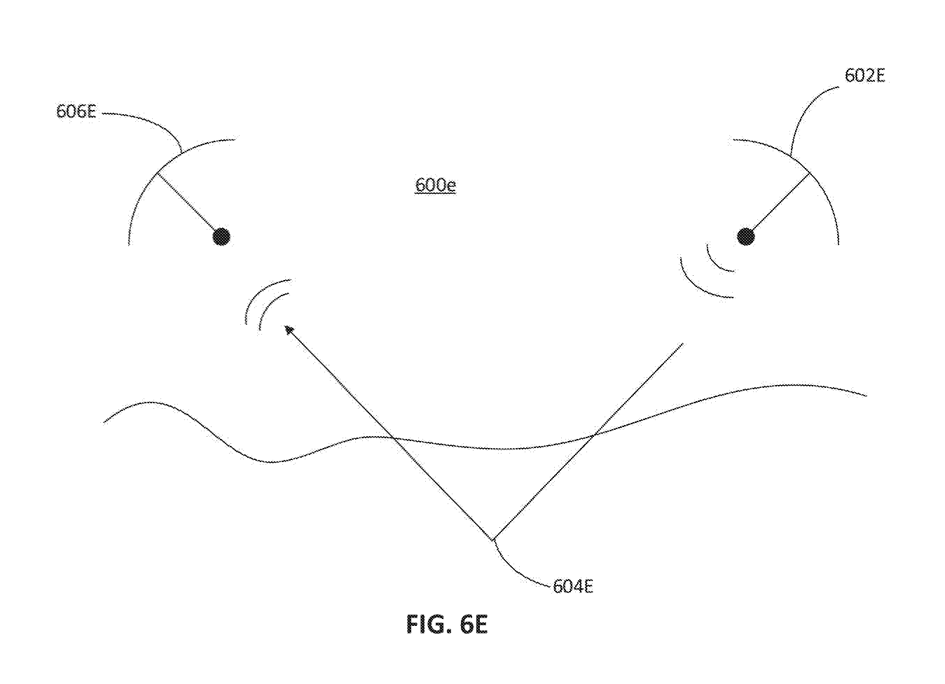

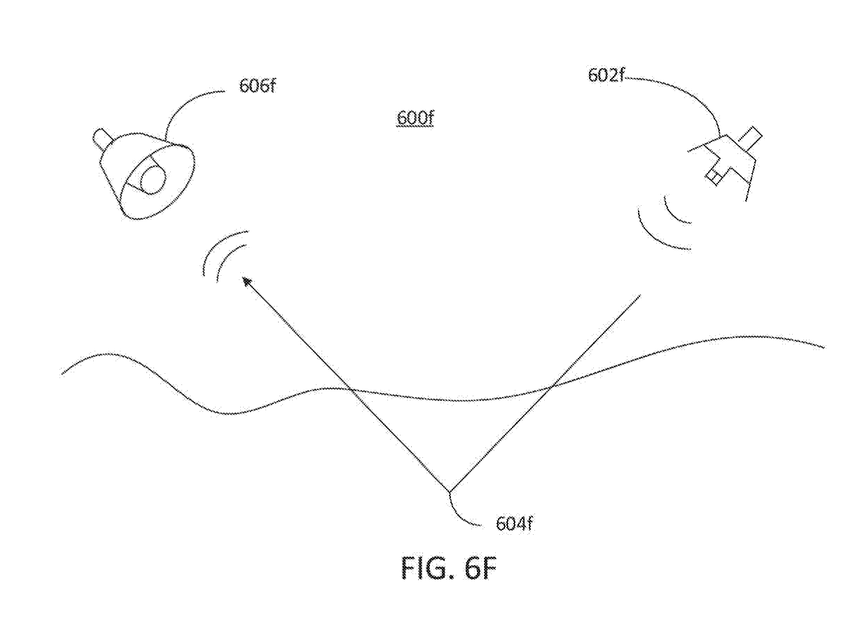

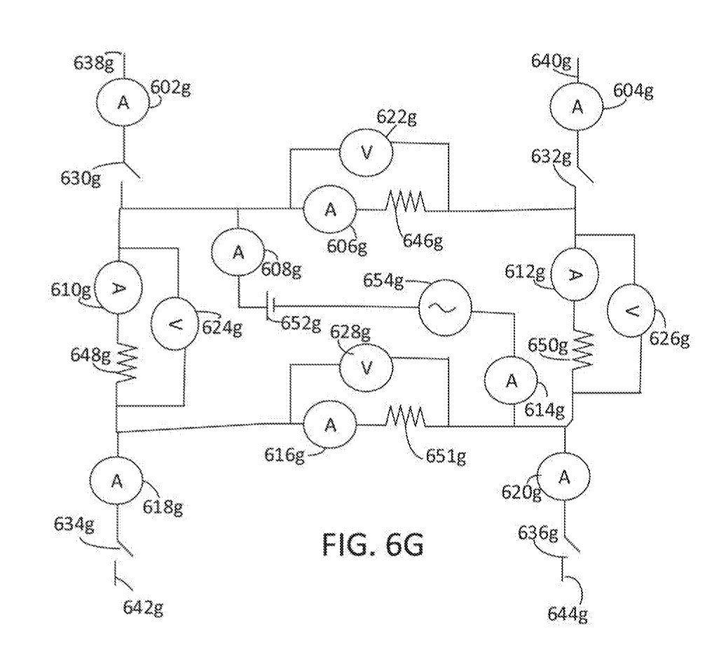

FIG. 6A shows a flowchart of an embodiment of a method for creating a mitigation property from the perspective of a governmental entity. The method may include steps of receive an application for a grant 602, determining whether to grant the application 604, optionally transmitting the grant funds to the mitigating entity 606, receiving funds from the mitigating entity for a government security 608, issuing a government security to the mitigating entity 610, paying out interest payments on the government security to the mitigating entity 612.

Receiving an application for a grant 602 includes receiving an application prepared by an entity to receive a grant. For example, the government entity 116 may receive an application, via the Internet, at government entity server 118 from mitigation entity server 106 on behalf of mitigating entity 104 for a grant to create a mitigation habitat.

Determining whether to grant the application 604 includes determining whether the application is sufficient to justify granting rights to the mitigation entity to develop a mitigation project at the site in question. Determining whether to grant the application 604 may also include determining whether the application is sufficient to justify the government the expenditure of the grant funds. The government entity 116 may deny the application on grounds of a failure of formalities, such as failing to complete necessary forms or failing to receive appropriate permission from other government entities. The government entity 116 may also deny the application on substantive grounds, for example, the application may describe a mitigation effort that is unlikely to succeed, the application may only create a habitat for a short time without reserving sufficient resources to maintain the habitat, the application may run afoul of other governmental policies, the application may fail to respect the laws of the United States or local laws of Native American people, a restoration proposed may be insufficient as an effort to justify issuing of a grant and eventually mitigation credits, or for any other reason for which the government may deny an application for a grant. The government may grant the application for grant. In an embodiment, the application is received electronically at the government entity server 118, stored electronically at the government entity server 118, reviewed, and the decision is returned to electronically, via mitigation entity server 106, to the mitigation entity 104. In an embodiment, the application may be reviewed electronically, by government entity server 118. In an embodiment, government entity server 118, may perform an initial determination as to whether to grant or deny the application, which is later further reviewed by a person.

Transmitting the grant funds to the mitigating entity 606 may include transmitting money to the mitigation entity 104. The transmitting 606 may be conducted physically using a check or cash or may be conducted electronically via a server over the Internet, for example. The transmitting 606 may be from the government entity 116 directly to the mitigating entity 104 directly or may be to a financial institution or financial institution server acting as a financial agent of the mitigating entity.

Receiving funds from the mitigating entity 104 for a government security 608 may include receiving funds from a private entity, and issuing government securities in return. The funds may be invested in any type of security including a government bond or other instrument, for example. In an embodiment, the funds may be received electronically from mitigation entity financial institution server 122 or from development financial institution server 126 at a government entity server 118 or at a server of a financial institution of government entity 116.

Issuing a government security to the mitigating entity 610 may include issuing an instrument representing equity in a government security. The government security may yield interest. In an embodiment, government entity 116 may electronically issue a government security and/or create an electronic record of the creation, ownership, payments made, and status of the security issued. Similarly, mitigation entity 104 may electronically receive the financial instrument and/or revenue payments resulting from the financial instrument, directly, at mitigation entity financial institution server 122. Mitigation server 106 and/or mitigation entity financial institution server 122 may receive an electronic version of the government security and/or store a record of the government security, payments received, and status of the security issued.

Paying out interest on the government security to the mitigating entity 612 includes transmitting funds to the mitigating entity as the interest earned on a government security. The paying out 612 may be from the government directly to the mitigating entity or may be to a financial institution or financial institution server acting as a financial agent of the mitigating entity. The mitigating entity may use the interest received from the government security to give a mitigation habitat an enduring quality. In an embodiment, government entity 116 may electronically send a payment and/or create an electronic record of the payment made, which may include updating the status of the security issued. Similarly, mitigation entity 104 may electronically receive the payment from the financial instrument at mitigation entity financial institution server 122. Mitigation server 106 and/or mitigation entity financial institution server 122 may receive an electronic version (and/or a physical version) of the government security and/or store a record of the government security, payments received, and/or update the status of the financial instrument.

In an embodiment, each of the steps of the method shown in FIG. 6A is a distinct step. In another embodiment, although depicted as distinct steps in FIG. 6A, steps 602-612 may not be distinct steps. In other embodiments, the method shown in FIG. 6A may not have all of the above steps and/or may have other steps in addition to or instead of those listed above. The steps of the method shown in FIG. 6A may be performed in another order. Subsets of the steps listed above as part of the method shown in FIG. 6A may be used to form their own method.

FIG. 6B shows an example of a habitat 620. Habitat 620 may include mitigation vegetation 622, body of water 624, river 626, river 628, overflow control 630, gate 632, reservoir 634, archeological site 636, native American site 638, path 640, path 642, visitor center 644, fences 648, 650, and 652, and gate 654. In other embodiments, the habitat 620 may not have all of the elements listed and/or may have other elements in addition to or instead of those listed.

Habitat 620 is located on a property purchased by a mitigation entity 104 for development into a habitat as mitigation for the building another project, such as a public infrastructure project. Habitat 620 may be an embodiment of mitigation property 102. Habitat 620 is created by altering a previous state of the property, such as by removing buildings and/or other man-made structures, altering the variety of wildlife on the property, and/or altering the landscape of the property, such as by changing the flow of water on the property to one that supports the desired wildlife and/or is better suited for the purposes that the habitat is desired. Habitat 620 may be a property that is restored to a prior state. Mitigation vegetation 622 is a vegetation that is planted as part of creating habitat 620. Mitigation vegetation may be a vegetation that is important to a Native American culture or religion, which is planted to form a part of the habitat. The mitigation vegetation may include plants that various Native Americans consider sacred and/or that are used for ceremonial purposes. Some example of plants that have ceremonial and/or religious significance are tobacco, sweet grass, sage, cedar, peyote cactus. Mitigation vegetation may include plants that have been used for medicinal purposes. Some examples of plants that are used for medicinal purposes are Acer glabrum var. douglasii (Douglas maple), Acer glabrum var. glabrum, Acer negundo (box elder), Acer saccharinum (silver maple), Acer saccharum (sugar maple), Actaea racemosa (black cohosh), Actaea rubra, (red baneberry), Agrimonia gryposepala, Alnus rhombifolia, Alnus rubra, Artemisia douglasiana, Artemisia ludoviciana, Arundinaria, Asarum canadense, Asclepias verticillata, Baccharis sarothroides, Balsamorhiza sagittata, Baptisia australis Betula occidentalis, Blephilia ciliata, Bloodroot, Calypso (orchid), Cardamine diphylla, Caulophyllum, Ceanothus integerrimus, Ceanothus velutinus, Chimaphila umbellata, Claytonia virginica (Virginia spring-beauty), Cleome serrulata, Commelina dianthifolia, Cornus sericea, Delphinium nudicaule, Devil's Club, Echinacea, Echinacea angustifolia, Encelia farinosa, Ephedra californica, Equisetum hyemale, Erigenia bulbosa, Eriodictyon crassifolium, Eryngium aquaticum, Erythrina herbacea, Eurybia macrophylla (bigleaf aster), Gaultheria hispidula (creeping snowberry) Gaultheria procumbens, Gentiana villosa, Catawba Geranium maculatum, Goldenseal, Gutierrezia microcephala, Hamamelis virginiana (Witch Hazel), Heracleum maximum, Holodiscus discolor, Holodiscus dumosus, Hydrangea arborescens, Hydrangea cinerea, Ilex verticillata (“fever bush”), Iris missouriensis, Jeffersonia diphylla, Juniperus communis Berberis root bark Juniperus scopulorum, Krascheninnikovia lanata, Larrea tridentata, Lobelia, Mahonia aquifolium, Mahonia nervosa, Mahonia repens, Malosma, Menispermum canadense, Osmunda claytoniana, Pectis papposa, Persicaria amphibia, Pinus strobus, Pluchea sericea, Podophyllum peltatum, Populus tremuloides, Prunus emarginata, Prunus virginiana, Pseudognaphalium obtusifolium, ssp obtusifolium, Ribes aureum, Ribes divaricatum, Ribes glandulosum (skunk currant), Ribes laxiflorum, Ribes oxyacanthoides, Salvia apiana, Salvia mellifera, Trichostema lanatum, Trichostema lanceolatum, Umbellularia, Viburnum prunifolium, Virginia Iris, and Yucca glauca.

Mitigation vegetation may include plants that have been used for Native American foods. Some examples of plants that are used for in Native American food are Abronia fragrans (snowball-sand verbena), Eurybia macrophylla (bigleaf aster), Gaultheria hispidula (creeping snowberry), and Pectis papposa. Mitigation vegetation may include plants that have been used for Native American for other purposes, such as Yucca glauca.

Mitigation vegetation 622 may be vegetation that previously grew in and/or was native to the area that has been restored as part of creating habitat 620. There may be multiple regions of mitigation vegetation throughout habitat 620. Mitigation vegetation 622 is optional. Body of water 624 is a manmade body of water formed as part of creating habitat 620. Body of water 624 may be needed to support plants and/or animals that are desired to be a part of the habitat 620. Body of water 624 is optional. Habitat 620 may include one or more bodies of water, and each may be a naturally occurring body of water or a manmade body of water. Rivers 626 and 628 are optional. River 626 feeds body of water 624, and river 628 drains body of water 624. Habitat 620 may include any number of a rivers and streams. Overflow control 630 may include a flashboard, riser, and/or gate for controlling the height of body of water 624 and/or controlling the location to which water leaves body of water 624, for example. Using overflow control 630, when the body of water 624 overflows, the location to which the water overflows may be controlled so as to reduce the damage of the overflow. For example, if the habitat includes an archeological site and/or a site on which native American remains and/or artifacts are located, when the level of body of water 624 reaches a certain threshold, a gate may be opened and/or a valve may open allowing water to leave body of water 624 to a location that is unlikely to adversely affect the archeological site and/or a site on which native American remains and/or artifacts. Overflow control 630 is optional. Gate 632 may control the rate at which water leaves body of water 624, which may thereby control the height and size of body of water 624. Gate 632 may be opened wider during periods of heavy rain fall and/or large snow melts and may be opened to a lesser extent when there is little precipitation and/or there is little snow melt. Gate 632 may include, may be accompanied with, and/or replaced by a riser, weir boards, and/or flashboards. Reservoir 634 may store excess water for use during dryer periods. During times in which water is plentiful reservoir 634 may be filled and during times in which water is scarce, that water in reservoir 634 may be used (e.g., for filling body of water 624, water plants, and/or other purposes) emptying reservoir 634. Reservoir 634 is optional. Archeological site 636 is a site in which artifacts of the past (e.g., fossils and/or artifacts of prehistoric man), which are not considered of importance to Native Americans, are located. Archeological site 636 may include an active dig site in which archeological artifacts are uncovered and/or may include locations where archeological artifacts are located, but are not currently being uncovered. Archeological site 636 is optional. There by may multiple archeological sites in habitat 620.

Native American site 638 is a site that Native Americans consider important. Native American site 638 may include a location that is considered sacred to Native Americans, that have remains of Native Americans, that have Native American artifacts, and/or is important to Native Americans for other reasons. There may be any number of and/or a variety of types of Native American sites.

Native American site 638 may include Native American remains and/or artifacts that are brought from other locations (e.g., remote locations) in order to brought to Native American site 638 and placed there as a safer permanent resting place.

Paths 640 and path 642 are paths for visitors to travel on and enjoy habitat 620, without disturbing sensitive parts of habitat 620. Paths 640 and 642 may include walking paths, roads, and/or paved walk ways. Visitor center 644 may be a location at which visitors are greeted. Visitor center 644 may include exhibits that explain the importance of habitat 620, the significance and variety of the wild life in habitat 620, archeological site 636, and/or Native American site 638. Visitor center 644 is optional. There may be multiple visitor centers in habitat 620, which may include different exhibits. Fences 648, 650, and 652 hinder the travelers from entering habitat 620 from at least certain directions. There may also be fences blocking travelers from entering particular sensitive areas of habitat 620, such as an area having a particular vegetation and/or animal, archeological sites, and/or Native American sites. Gate 654 controls some degree of the ease of access that visitors to habitat have 620. Gate 654 may be closed and opened according to when visitors are welcome to enter and when visitors are not welcome. Gate 654 is optional. There may be multiple gates in habitat 620 that each may encourage and/or discourage visitors from entering particular parts of habitat 620 and/or the direction, via which visitors enter habitat 620.

FIG. 6C shows an example of a development property 115. In the example of FIG. 6C, development property 115 include a divided highway 600c having a first group of lanes 602c and 604c. In other embodiments, development property 115 may not have all of the above steps and/or may have other steps in addition to or instead of those listed above.

Divided highway 600c is just one of many example of a public infrastructure project. First group of lanes 602c has a group of lanes for traveling in one direction. Second group of lanes 604c has a group of lanes for traveling in the opposite direction from that of first group of lane 602c direction.

FIGS. 6D-6G show examples of instruments that may be used for determining the locations of items of significance to Native Americans and/or archeologists. Based on the measurements of the instruments of FIGS. 6D-6G, an archeological sites and/or native American sites (such as Native American site 636 and archeological site 638) may be established.

FIG. 6D shows an embodiment of a magnetometer 600d. Magnetometer 600d may include voltage source 602d, source coil 604d, point of reflection 606d, pickup coil 608d, and ammeter 610d. In other embodiments, the magnetometer 600d may not have all of the above steps and/or may have other steps in addition to or instead of those listed above.

Magnetometer 600d. may be used for finding items significant to Native Americans and/or significant for archeological purposes. Voltage source 602d generates a voltage causing a current to flow through the source coils. Optionally, there may be a resistor in series with the source coil. Source coil 604d generates a magnetic field as a result of a voltage source 602d generating a voltage, which in-turn generates a current flowing through source coils 604d. Point of reflection 606d is a point below the ground at which a part of the some of the magnetic field is reflected. Pickup coil 608d receives the reflected magnetic field. Ammeter 610d measures the current in pickup coil 608d, from which the magnetic field incident on the pickup coil can be inferred. Variations in reflected magnetic signal and the time of travel is indicative of structures under the ground.

FIG. 6E shows an embodiment of ground penetrating radar 600e. Ground penetrating radar 600e may include transmitter 602e, point of reflection 604e, receiver 606e. In other embodiments, ground penetrating radar 600e may not have all of the above steps and/or may have other steps in addition to or instead of those listed above.

Ground penetrating radar 600e may be used for finding items significant to Native Americans and/or significant for archeological purposes. Transmitter 602e generates a radio frequency electromagnetic signal which is directed into the ground. Point of reflection 604e is a point below the ground at which a part of the some of the electromagnetic signal is reflected. Receiver 606e receives the reflected electromagnetic signal. The variation of the strength of the reflected electromagnetic signal and the time of travel is indicative of the structures under the ground.

FIG. 6F shows an embodiment of sonar system 600f. Sonar system 600f may include sound source 602f, point of reflection 604f, receiver 606f. In other embodiments, sonar system 600f may not have all of the above steps and/or may have other steps in addition to or instead of those listed above.

Sonar system 600f may be used for finding items significant to Native Americans and/or significant for archeological purposes. Sound source 602f generates sound signal, which is directed into the ground. Point of reflection 604f is a point below the ground at which a part of sound signal is reflected. Receiver 606f receives the reflected sound signal. The variation of the strength of the reflected signal and the time of travel is indicative of the structures under the ground.

FIG. 6G shows an embodiment of a resistance meter 600g. Resistance meter 600g may include ammeters 602g-620g, voltmeters 622g-628g, switches 630g-636g, probes 638g-644g, resistors 646g-651g, direct current voltage source 652g, and alternating current voltage source 654g. In other embodiments, resistance meter 600g may not have all of the above steps and/or may have other steps in addition to or instead of those listed above.

Ammeters 602g, 604g, 618g, and 620g measure the currents in the four probes. Ammeters 606g, 610g, 612g, and 616g measure the current through the resistors that have known values. Based the ammeter readings and the known resistance, the voltage drops across the known resistances can be determined. Ammeters 608g and 614g measure the current flowing into and out of the voltage sources. Based on the currents in the four probes inferences can be made about the resistivity of the earth through which the current travels between the probes. Voltmeters 622g-628g measure the voltage drop across the known resistors. Based on the voltage readings the current through the known resistors can be computed. Ammeters 606g, 610g, 612g, and 616g and voltmeters 622g-628g are optional. Only one ammeter or one voltmeter is needed for each know resistor to determine the current through and voltage across each known resistor. Switches 630g-634g connect and disconnect each of the four probes, respectively. Switches 630g-634g may be operated electronically and automatically and/or manually. By using only two probes at a time, the resistance provided by the earth between any two probes may be easily determined, and the resistivity of the earth, the current density, and/or electric fields may be inferred. Alternatively, or additionally, all four probes may be turned one simultaneously and resistances, the resistivity of the earth, the current density, and/or electric fields may be inferred. Anomalies in the resistance values may be indicative of the presence of artifacts. Alternatively, the inferred the resistivity of the earth, the current density, and/or electric fields may be used to create an image that is indicative of the structures in the ground.

Probes 638g-644g are placed in the ground by knowing the current in each probe and the voltage drop between each probe, the resistance of the earth between the probes can be computed. By comparing the currents in the probes and the voltage drops between the probes to a computer model electric field, currents, resistivity, current density, and conductivity, an image can be inferred of changes in the electric field, currents, resistivity, current density, and conductivity, which may indicate the presence of different structures in the earth, which in-turn may be indicative of the location of items of significance to Native Americans and/or archeologists.

Resistors 646g-651g each have a known value. By comparing the known value of the resistor to the current measured by one of the ammeter adjacent to and in series with the resistor, the voltage across the resistor may be computed. By comparing the known value of the resistor to the voltage measured by one of the voltmeters that is in parallel with the resistor, the current traveling through the resistor may be computed. Voltage source 652g is a direct voltage source. The amplitudes of voltages source 652g and 654 may each be adjustable so that the response of the earth to different voltage amplitudes and/or frequencies may be measured.

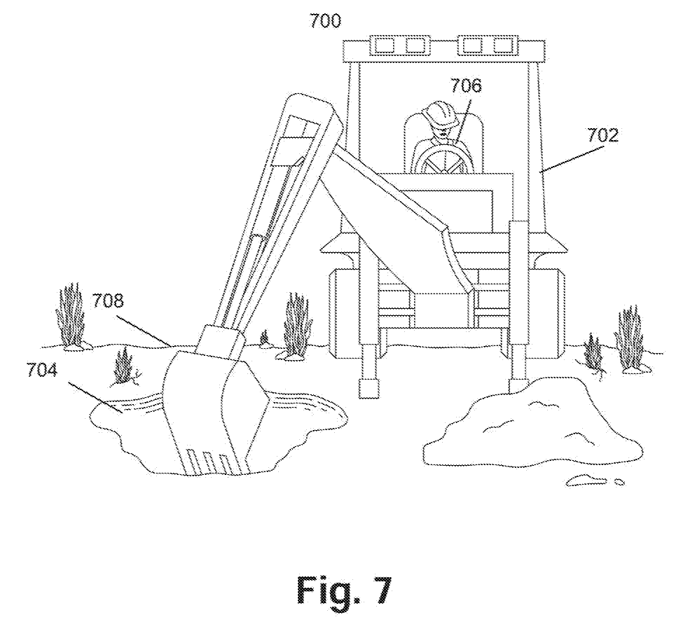

FIG. 7 shows an embodiment of a digging activity to create a mitigation property. The activity 700 may include a digging machine 702, earth 704, a person 706, and the mitigation property 708. In other embodiments, the activity 700 may not have all of the elements listed and/or may have other elements in addition to or instead of those listed.

The digging machine 702 is a device used to move and remove earth. The digging machine 702 may be, for example, a tractor or shovel. Alternatively, machine 702 may be replaced with a hoe, a post digger, a backhoe, a plow, or a tiller. Earth 704 is ground or soil. A person 706 is a human being. The mitigation property 708 is a place on which a mitigation entity is creating a mitigation habitat. The person 706 may use the digging machine 702 to move earth 704 in order to create a mitigation property 708. The activity 700 may be accomplished using the interest derived from a government security. The activity 700 may be part of creating or restoring an enduring mitigation habitat. Activity 700 may be to create a water reservoir, lay a foundation of a building or fence, divert water (e.g., to build a dam), remove evasive species, change the contour of the land, for example.

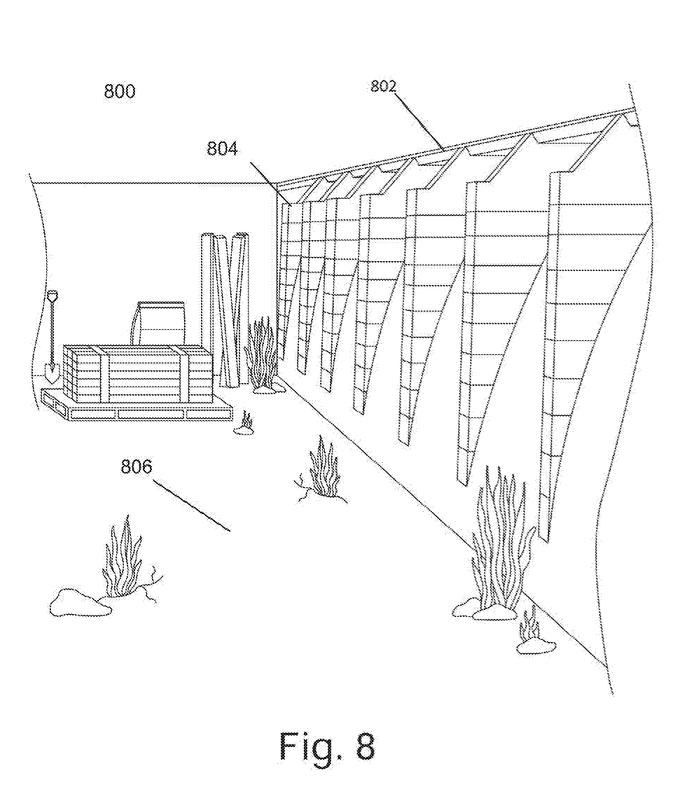

FIG. 8 shows an embodiment of diverting water to create a mitigation property. The diverting water 800 may be performed by placing a dam 804, on a mitigation property 806. A dam 804 is a structure meant to prevent or divert the flow of water. The dam 804 may be erected in order to create a water reservoir to maintain a watershed in a habitat or mitigation property 806. The diverting water 800 may be accomplished using interest derived from a government issued security. The diverting 800 may be part of creating or restoring an enduring mitigation habitat.

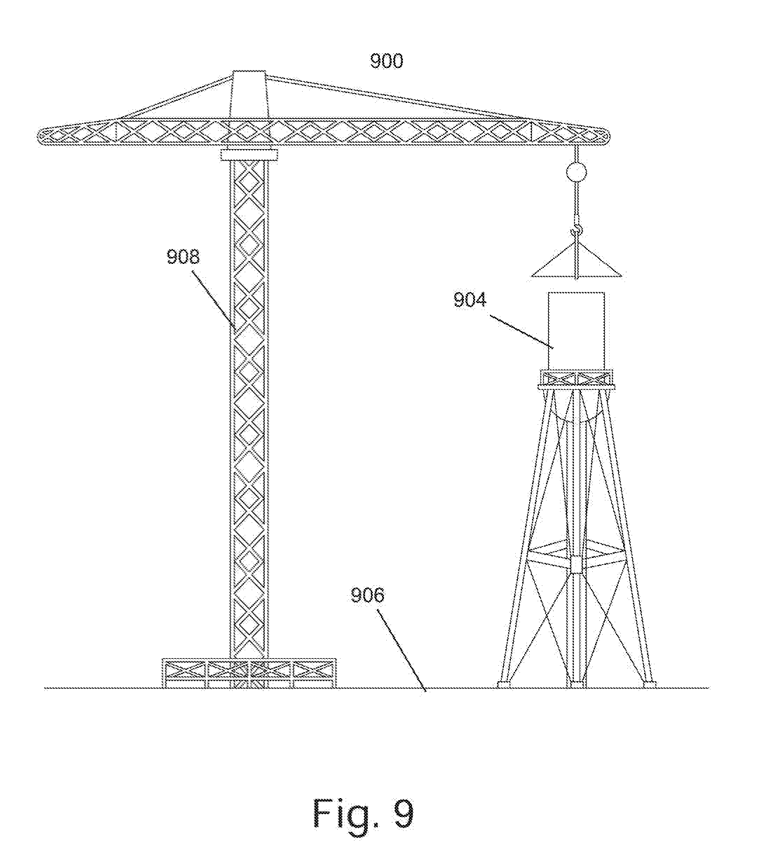

FIG. 9 shows an embodiment of a building or repairing activity to create a mitigation property. The building or repairing activity 900 may involve erecting a water tower 904, on a mitigation property 906. Crane 908 may assemble water tower 904. The building or repairing activity 900 may be accomplished using interest derived from a government issued security. The building activity 900 may be part of creating or restoring an enduring mitigation habitat. The water tower 904 may store water, which may be used to keep the watershed above a particular level.

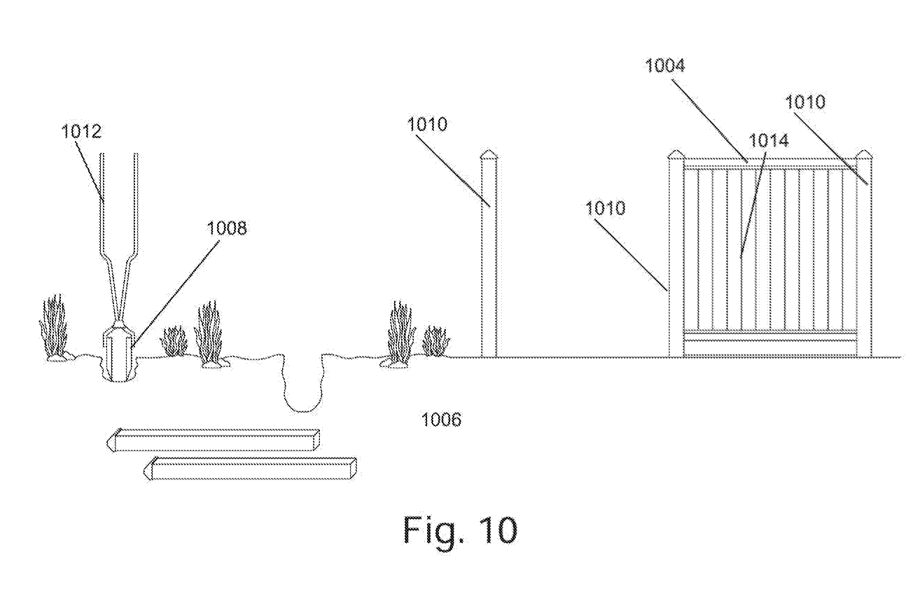

FIG. 10 shows an embodiment 1000 of erecting or repairing a fence, which may establish structural boundaries for portions of the mitigation property. The placing of species 1000 may involve erecting or repairing a fence 1004, on a mitigation property 1006. The erecting or repairing of the fence may limit traffic of humans and evasive species through the habitat, which can damage the habitat. The fence 1004 may be erected by placing an anchor 1008 in the ground and attaching a post 1010 to the anchor 1008. Tool 1012 may be used to drive anchor 1008 into the ground. Once multiple posts 1010 have been anchored to the ground, material 1014, such as a wire mesh or wooden lattice may be attached to the posts blocking the space between the posts 1010. Embodiment 1000 may be accomplished using interest derived from a government issued security. The placing of species 1000 may be part of creating or restoring an enduring mitigation habitat.

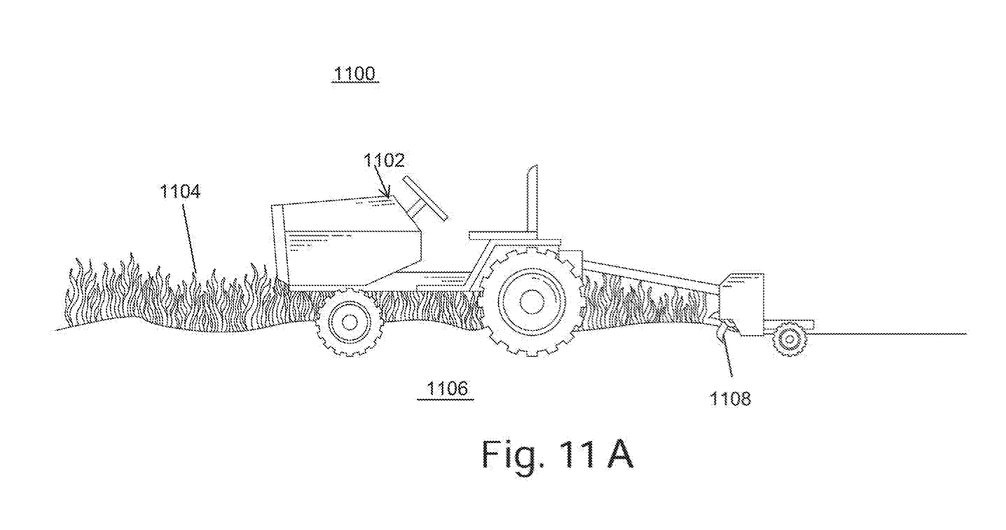

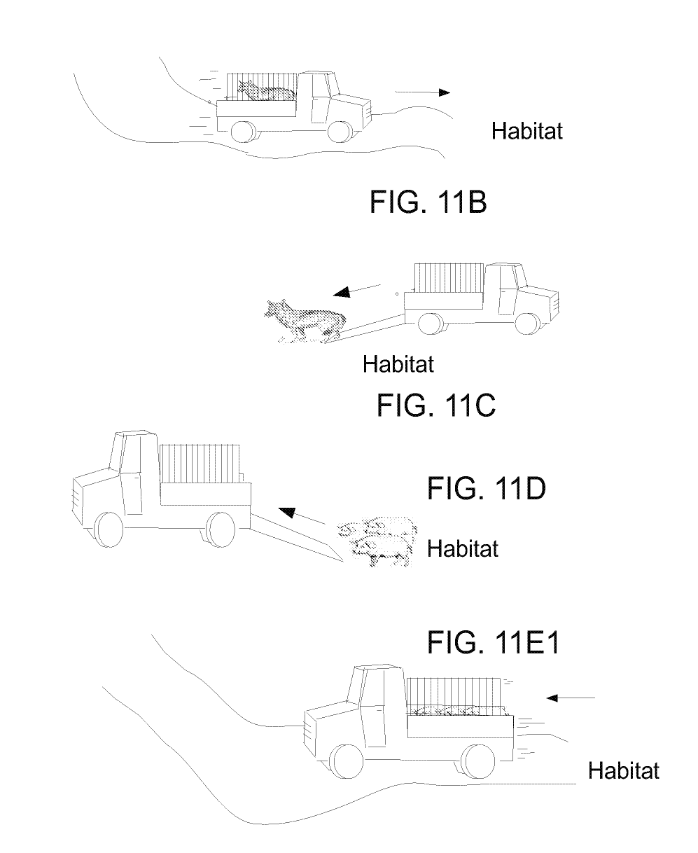

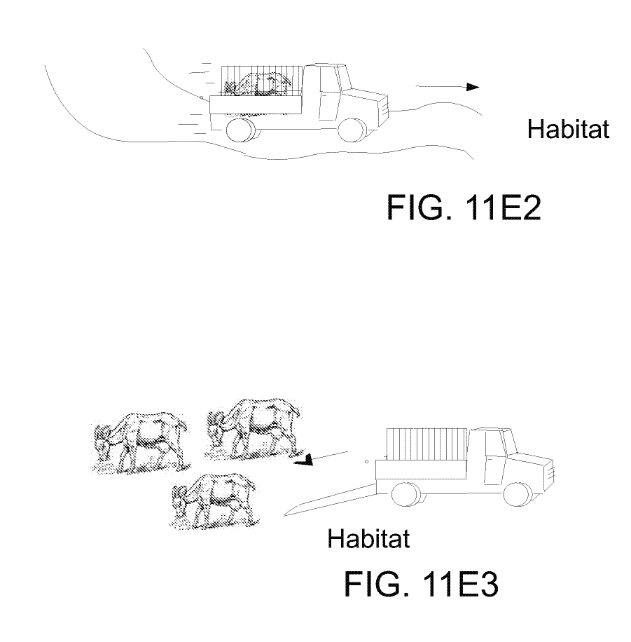

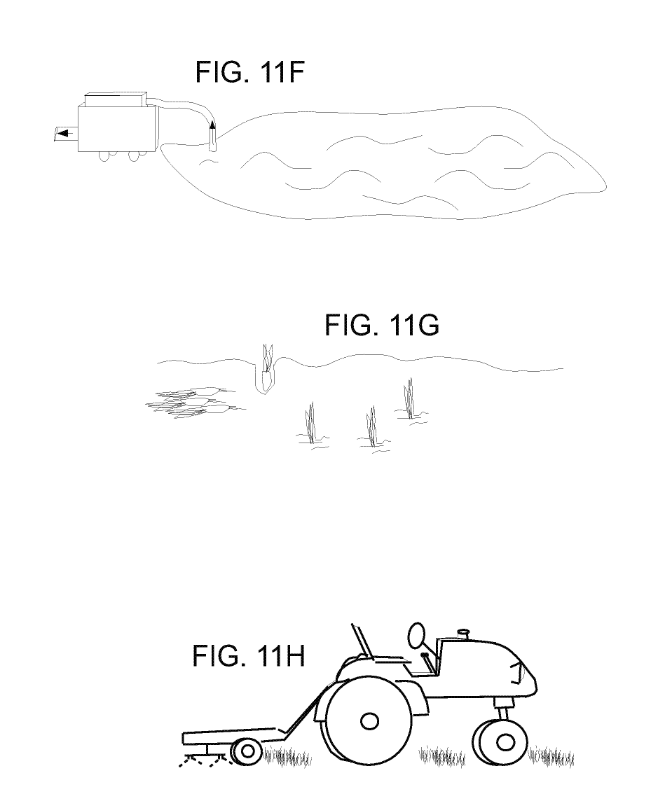

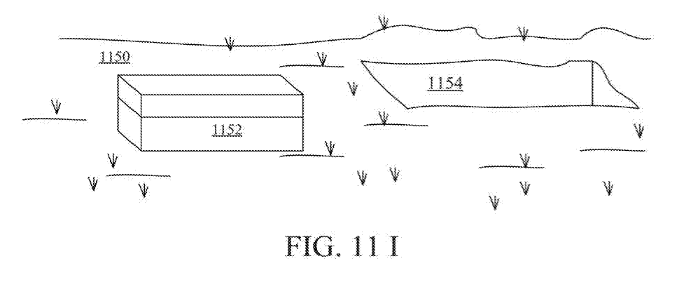

FIG. 11A shows an embodiment of removing local invasive species 1100 to create a mitigation property. The removing of the local invasive species 1100 may include removing a plant that is not native to the mitigation property. The removing of the local invasive species 1100 may involve a tractor 1102 (or other machinery) removing an invasive species 1104 on a mitigation property 1106. In an embodiment, tractor 1102 includes rotary blade 1108 for cutting the green chlorophyll-containing portions of the invasive species. Repeated cutting of the green leafy portions of the invasive species may kill the invasive species within 3 or 4 years. In other embodiments, the invasive species may be uprooted removing the entire root and/or may be treated with herbicides. After the invasive species is removed the invasive species may be disposed of by burning the invasive species or drying out the invasive species and throwing the dried invasive species in the trash. The removing of the local invasive species 1100 may be accomplished using interest derived from a government issued security. The removing of the local invasive species 1100 may be part of creating or restoring an enduring mitigation habitat.

FIG. 11B shows bringing a desired animal species to a habitat, via a vehicle, to a habitat. The desired species may be a species that is in peril and/or that at one time was native to the area. The desired species may be a predator, which may remove or help remove invasive species. The species that is introduced for removing an invasive species may be a herbivore, which may be used to remove an invasive species of plant. The species may be introduced temporarily to remove an invasive species and then removed from the habitat, or may be introduced permanently.

FIG. 11C shows the actual releasing the desired animal species into the habitat. The pen or cage in which the desired animal was transported is opened, and animal is allowed to roam freely.

FIG. 11D shows removing an invasive animal species from a habitat. The species may be corralled or lured into a pen for removal from the habitat.

FIG. 11E1 shows transporting the invasive species animal out of the habitat to another location, via a vehicle, after the invasive species is removed from the habitat. Likewise, a desired species may be removed temporarily from the habitat, in a similar manner, so that the animals are not hurt while work is being performed in the habitat.

FIG. 11E2 shows bringing a desired animal species to a habitat, via a vehicle, to a habitat. The desired species (e.g., a goat) may be an herbivore that consumes invasive species. The species may be introduced temporarily to remove then the invasive species and then removed from the habitat, or may be introduced permanently.

FIG. 11E3 shows the actual releasing the desired animal species into the habitat. The pen or cage in which the desired animal was transported is opened, and animal is allowed to roam freely.

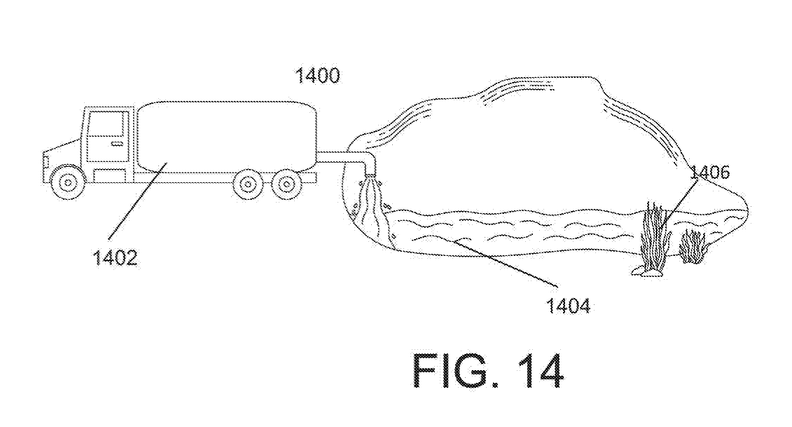

FIG. 11F shows removing water from a body of water, which may be used a way of removing an invasive species, such as an invasive species of fish or other species that lives in water. After the water is removed, and the invasive water species is removed, the water may be returned to the body of water and the desired species may be added back to the body of water (returning water to the body of the water will also be discussed in conjunction with FIG. 14).

FIG. 11G shows introducing a desired species of plant to a habitat. The plants may be planted individually or may be planted by a machine into the habitat.

FIG. 11H shows another embodiment of removing and/or introducing a species to a habitat. An herbicide may be used to kill an invasive species, which may be delivered by a spray from a machine that spays the herbicide, which in turn may be transported by a tractor or other vehicle. Alternatively, a similar method maybe used for distributing seeds within the habitat to introduce a desired species of plant, where the machine attached to the tractor that sprays the herbicides is replaced with a similar spraying machine that sprays seeds.

FIG. 11I shows an example of repatriating remains and/or artifacts to a habitat. FIG. 11I shows a habitat 1150, container 1152, and hole 1154. Habitat 1150 may be an embodiment of habitat 114 or 620, for example. If habitat 1150 was not previously significant to Native Americans, habitat 1150 becomes a site significant to Native Americans as a result of placing native American remains in the habitat. Container 1152 may contain remains of one or more Native Americans and/or other items of significance to Native Americans. The contents of container 1152 may have come from another site that is not contiguous with habitat 1150. Hole 1154 is a hole that was dug for placing container 1152. Container 1152 is optional. The Native American remains and/or other items of significance may be placed in the ground without a container (e.g., with no covering or covered in a cloth), according to the rituals, religion, and/or customs of the Native Americans that the remains and/or other items are associated with.

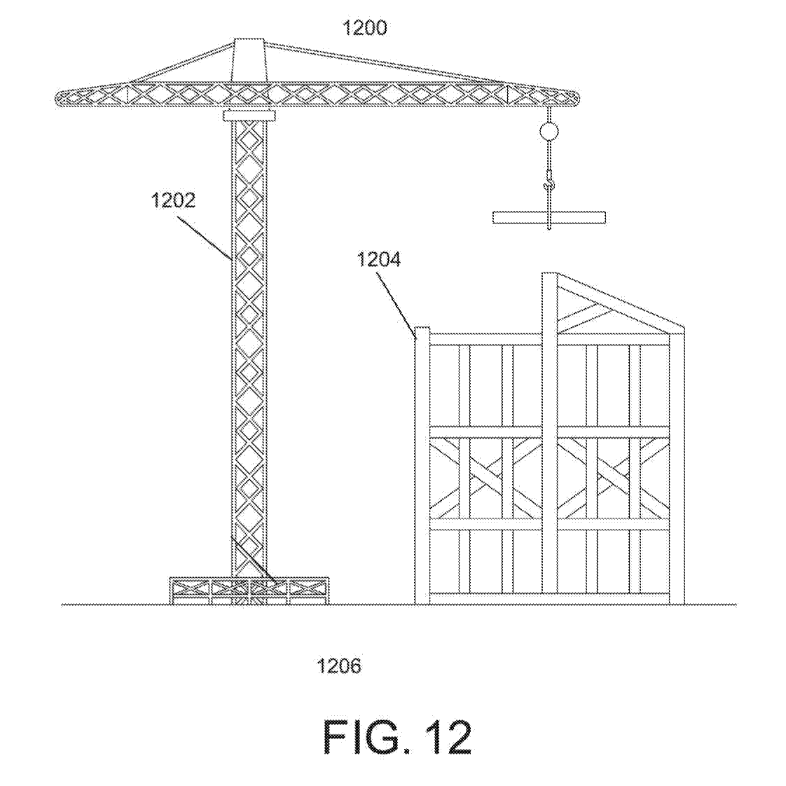

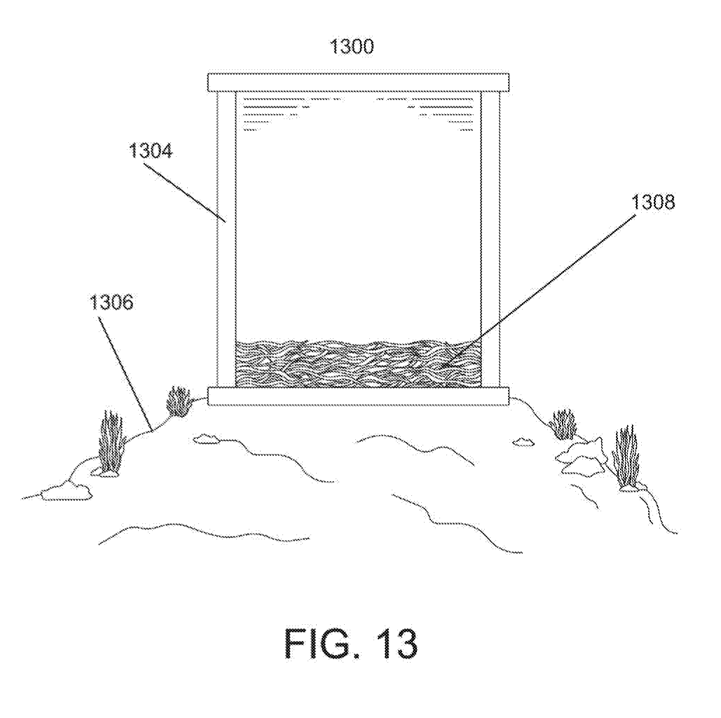

FIG. 12 shows an embodiment of erecting or repairing of a cultural structure to create a multiuse mitigation property. The erecting or repairing 1200 may involve a crane 1202 erecting or repairing of a cultural center 1204 on a mitigation property 1206. The erecting or repairing 1200 may be accomplished using interest derived from a government issued security. The erecting 1200 may be part of creating or restoring an enduring multiuse mitigation habitat. For instance, a government entity may refuse to fund a mitigation habitat with a grant if the government entity does not see a greater purpose for the land, for instance a multiuse property.

FIG. 13 shows an embodiment 1300 of creating a shelter reintroducing a species that is not present or that is present in relatively small numbers to create a mitigation property. The creating 1300 may involve a placing a shelter 1302 on a mitigation property 1306 where young members of a new species may live until the species is re-established in the mitigation property 1306. In an embodiment, nesting material 1308 is included in the shelter so that the species is comfortable in the shelter. The creating 1300 may be accomplished using interest derived from a government issued security. The creating 1300 may be part of creating or restoring an enduring mitigation habitat.

FIG. 14 shows an embodiment of filling 1400, a water basin to create a pond on the mitigation property. The filling 1400 may involve a tanker truck bring water filling a pond 1404 on a mitigation property 1406. In an embodiment the pond may need to first be dug (e.g., with tractor 702). The filling 1400 may be accomplished using interest derived from a government issued security. The filling 1400 may be part of creating or restoring an enduring mitigation habitat.

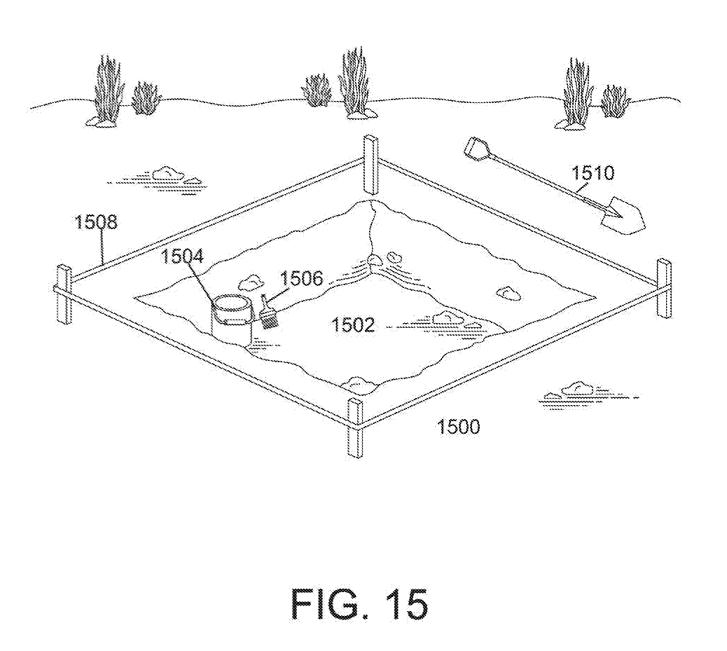

FIG. 15 shows an embodiment of removing archeological artifacts from the ground so that the artifacts can be relocated to a location where the artifacts will not be disturbed. The removing 1500 may involve identifying a site 1502 having archeologically significant artifacts and collecting the artifacts. Container 1504 may store dirt that is expected to have artifacts, so that the dirt may be transported and examined in a laboratory. The artifacts may be cleaned with a cleaning utensil 1506 (e.g., a brush) and site 1502 may be marked with boundary markers 1508. Dirt that is expected not to contain artifacts may be removed using shovel 1510. The removing 1500 of archeological artifacts may be accomplished using interest derived from a government issued security. The removing 1500 of the archeological artifacts may be part of creating or restoring an enduring mitigation habitat. In an embodiment, site 1502 is located within the habitat, and archeological site 636 and/or Native American site 638 may be examples of site 1502. In an embodiment, site 1504 is remote from the habitat, and the remains and/or artifacts taken from site 1502 may be transported to the habitat and placed to rest within the habitat (see FIG. 11 I, for example) at a site such as archeological site 636 and/or Native American site 638 may be examples of site 1502. In an embodiment, there may be one or more sites, such as site 1502, that are located within the habitat and/or there may be one or more sites, such as site 1502 that are located outside of the habitat and whose contents are brought to the habitat and permanently located at one or more sites within the habitat.

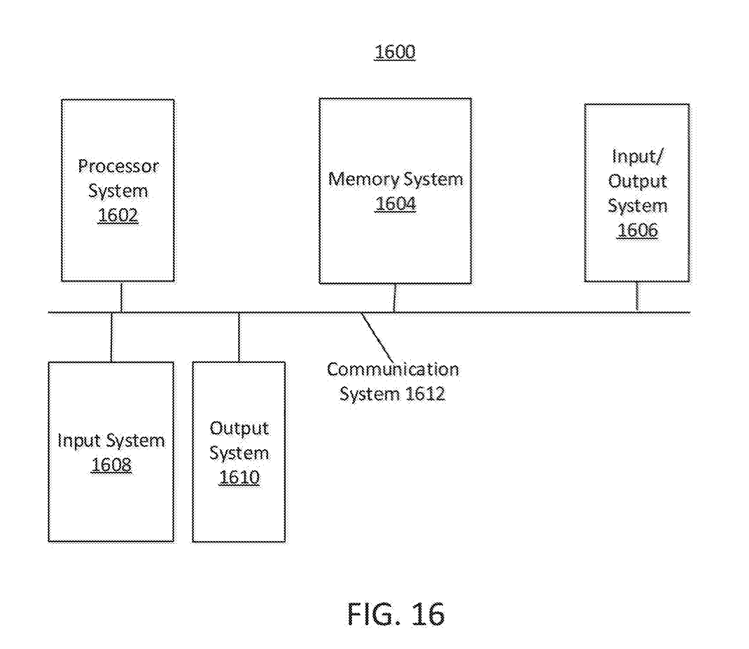

FIG. 16 shows a block diagram of an embodiment of a computer system 1600. The computer system 1600 may include, for example, a processor system 1602, a memory system 1604, an input/output system 1606, an input system 1608, an output system 1610, and a communication system 1612. In other embodiments, the computer system 1600 may not have all of the elements listed and/or may have other elements in addition to or instead of those listed.

Computer system 1600 may be used as mitigation entity server 106, a development entity server 110, a government entity server 118, a server of a financial instrumentation of government entity 116, a mitigation entity financial institution server 122, and a development financial institution server 126.

The processor system 1602 is a system that processes commands stored in the memory system. The processor system 1602 may include any one of, some of, any combination of, or all of multiple parallel processors, a single processor, a system of processors having one or more central processors, logic circuits, and/or one or more specialized processors dedicated to specific tasks. The specialized processors may include a video processor and math processor, for example.

Memory system 1604 may include, for example, any one of, some of, any combination of, or all of a long term storage system, such as a hard drive; a short term storage system, such as random access memory; a removable storage system, such as a floppy drive or a removable drive; and/or flash memory. Memory system 1604 may include one or more machine-readable mediums that may store a variety of different types of information. The term machine-readable medium is used to refer to any non-transient medium capable carrying information that is readable by a machine. One example of a machine-readable medium is a non-transient computer-readable medium. Another example of a machine-readable medium is paper having holes that are detected that trigger different mechanical, electrical, and/or logic responses. The memory system 1604 may include, for example, any one of, some of, any combination of, or all of a long term storage system, such as a hard drive; a short term storage system, such as a random access memory. The memory may include, for example, read-only memory (“ROM”), random access memory (“RAM”), erasable programmable read only memory (“EPROM”), electrically erasable programmable read only access memory (“EEPROM”), a dedicated state logic circuit, flash, non-volatile random access memory (“NVRAM”). In an embodiment, the memory system 1604 may include a removable storage system such as a disk drive, floppy drive or a removable drive; and/or flash memory. The memory system 1604 may include one or more machine-readable media that may store a variety of different types of information. The term machine-readable media may be used to refer to any non-transient medium capable of carrying information that is readable by a machine. One example of a machine-readable medium is a computer-readable medium. The memory system 1604 may also store information and algorithms necessary to execute functions, such as variables, intermediate results, and constants, for example. For instance, the memory system 1604 may store commands to be executed by the processor system 1602 in order to perform functions of any of the servers and computers in this specification. Memory system 1604 may store instructions for processing financial transactions, such as for wiring a payment, receiving a payment processing a virtual or paper check, computing changes to account balances, storing a record of the changes to the account balances, and/or recording a financial transaction. Computer system 1600 may include one or more machine instructions for recording and tracking the status of a financial instrument, such as a database of financial information. If computer system 1600 is a server of a government entity, memory system 1604 may store one or more machine instructions, which when implemented cause a processor to issue financial instruments, asses the number of mitigation credits that need to be purchased to mitigate for a public infrastructure project, and track mitigation credits. If computer system 1600 is database 119 or mitigation entity server 106, memory system 1604 may include a database of locations of Native American remains correlated with information about the Native American artifacts at each location, such as the area in which the remains are spread out, the depth at which the artifacts are located, and/or the depth occupied by the remains. The database in memory system 1604 may store information about the significance of the remains and/or the tribes or groups to which the remains are significant. The database in memory system 1604 may include contact information, such as phone numbers, mailing addresses, e-mail addresses, and/or addresses on a social network, of an organization or person that represents the group of interest.

Input/output system 1606 may include devices that have the dual function as input and output devices. For example, input/output system 1606 may include one or more touch sensitive screens, which display an image and therefore are an output device and accept input when the screens are pressed by a finger or stylus, for example. The touch sensitive screens may be sensitive to heat and/or pressure. One or more of the input/output devices may be sensitive to a voltage or current produced by a stylus, for example. Input/output system 1606 is optional, and may be used in addition to or in place of the output system and/or input system. The input/output system 1606 includes one or more devices that are used for both receiving input and transmitting output. The input/output system 1606 may include devices that are used for both input and output, such as a touch screen, USB ports, Ethernet ports, peripheral device ports, radio transceiver (e.g., for wirelessly connecting to a network), and/or a network interface. Sensors, actuators and/or controllers may be connected to input/output system 1606.

Input system 1608 may include any one of, some of, any combination of, or all of a keyboard system, a mouse system, a track ball system, a track pad system, buttons on a handheld system, a scanner system, a microphone system, a connection to a sound system, and/or a connection and/or interface system to a computer system, intranet, and/or internet (e.g., IrDA, USB), for example. The input system 1608 may include connections and hardware for entering input in to the system, such as a keyboard, microphone, camera, key pad, or pointing devices. Pointing devices are devices that move a pointer on a screen. Some examples of cursor devices are mice, track balls, and touch pads.

The output system 1610 is a system of one or more devices that send or present output of computer 1600. Output system 1610 may include any one of, some of, any combination of, or all of a monitor system, a handheld display system, a printer system, a speaker system, a connection or interface system to a sound system, an interface system to peripheral devices and/or a connection and/or interface system to a computer system, intranet, and/or internet, for example.

Communications system 1612 communicatively links output system 1602, input system 1604, memory system 1606, processor system 1608, and/or input/output system 1614 to each other. Communications system 1612 may include any one of, some of, any combination of, or all of electrical cables, fiber optic cables, and/or means of sending signals through air or water (e.g. wireless communications), or the like. Some examples of means of sending signals through air and/or water include systems for transmitting electromagnetic waves such as infrared and/or radio waves and/or systems for sending sound waves. The communication protocol may include logic that determines which device or system controls a communication bus at a given instant.

In different embodiments, the computer system 1600 may be a computer or server for a mitigation entity, a mitigation entity financial institution, a development entity, a development entity financial institution, a government entity, and a government entity financial institution, for example.

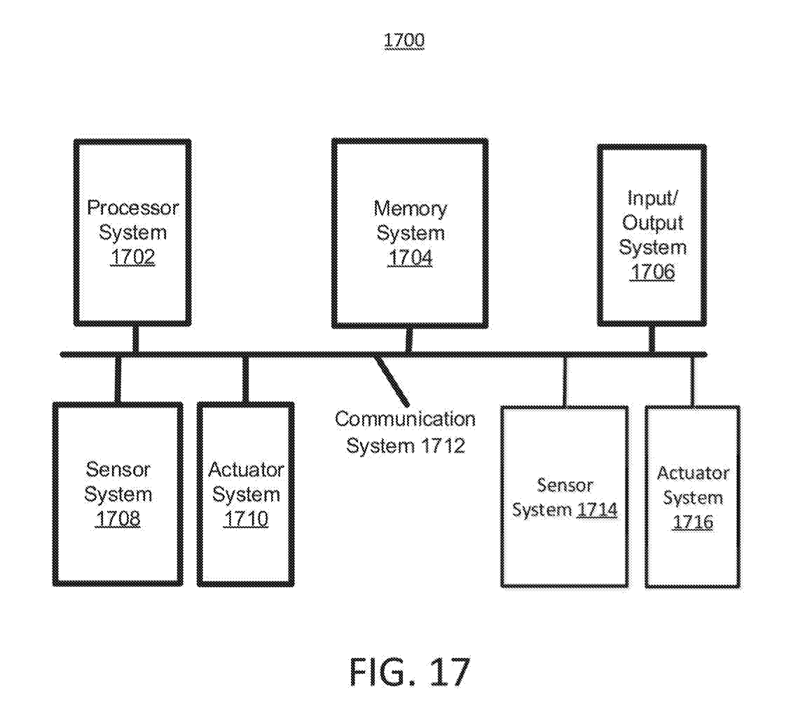

FIG. 17 shows a block diagram of an embodiment of a controller system 1700. The controller system 1700 may include, for example, a processor system 1702, a memory system 1704, an input output/system 1706, a sensor system 1708, an actuator system 1710, a communications system 1712, a sensor system 1714, and an actuator system 1716. In other embodiments, the computer system 1700 may not have all of the elements listed and/or may have other elements in addition to or instead of those listed.

Controller system 1700 may be a controller for an electrical resistance meter, ground-penetrating radar (GPR), and/or electromagnetic (EM) conductivity meter.

Controller system 1700 may be part of an instrument for detecting Native American remains, monitoring water flow, water depth, and/or animal populations.

The processor system 1702, the memory system 1704, the input output/system 1706, the sensor system 1708, the actuator system 1710, the communications system 1712, sensor system 1714 and actuator system 1716 are embodiments of the processor system 1602, the memory system 1604, the input output/system 1606, the input system 1608, the output system 1610, and the communications system 1612, which were described in connection with FIG. 16. However, machine instructions stored in memory system 1604 and implemented by processor system 1702 would be different in than in memory system 1704 and implemented by controller 1700.

In controller 1700, memory system 1704 may also include one or more machine-readable media that may store a variety of different types of information, and store variables, intermediates, results, constants, and the like necessary to execute functions. For instance, memory system 1704 may store instructions for performing functions associated with, an electrical resistance meter, ground-penetrating radar (GPR), and/or electromagnetic (EM) conductivity meter, memory system 1704 may store machine instructions for measuring resistance, measuring GPR data, and/or conductivity of the ground between probes. Memory system 1704 may include one or more machine instructions for creating a plan view map, and/or a vertical profile of the resistance, measuring GPR data, and/or conductivity measurements. Memory system 1704 may also store drivers for controlling and interfacing with equipment for searching for American Native Artifacts, such the magnetometer, electrical resistance meter, ground-penetrating radar (GPR) and/or electromagnetic (EM) conductivity meter.

The sensor system 1714 is a system of one or more devices that detects and/or measures physical characteristics and output a data stream. The sensor system 1608 may be used to detect environmental conditions, including, for example, temperature, foot traffic, barometric pressure, humidity, water levels in water sources, flow-rates of water in a water source, the presence of Native American remains or cultural artifacts, pH, or presence or quantity of chemicals. The sensor system 1608 may be an element of an imaging device with which a user can view buried items, the imaging device displaying an image representing the buried items. The imaging device may allow a user to determine the location of Native American remains or cultural artifacts.

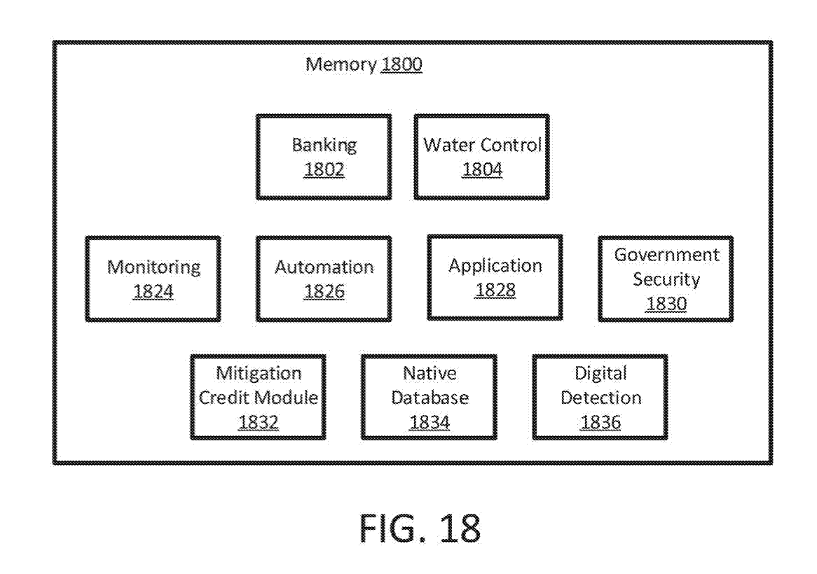

The actuator system 1710 is a device for generating a physical change. The actuator system 1710 may take actions based on instructions received from the processor system 1702. For example, in response to system 1708 detecting that the pH of the water is different than desired, actuator 1710 may release a substance e.g., minerals into the water to adjust the pH. Upon detecting that the water level in a particular area is low, actuator 1710 may adjust the degree to which a gate is open, the thereby affect the flow of water. Actuator 1710 may perform any of the steps in the embodiments of methods associated with FIGS. 18-21, for example.

FIG. 18 shows a block diagram of an embodiment of the memory system of a mitigating entity computer system. The memory system 1800 may include, for example, a banking module 1802, a water control a monitoring module 1824, an automation module 1826, an application module 1828, a government security module 1830, a mitigation credit transmitter 1832, a Native American database 1834, and a digital detection module 1836. In other embodiments, the memory system 1800 may not have all of the elements listed and/or may have other elements in addition to or instead of those listed.

The modules stored in memory system 1800 may be executed by a processor system or logic circuit. The memory system 1800 may be an embodiment of the memory system 1604 or 1704.

The banking module 1802 is a module that conducts financial transactions. The banking module 1802 conducts financial transactions and tracks the money in electronic banking accounts. Banking module 1802 transfers money to and/or from a government institution, instructs a financial institution or financial institution server to transmit or hold funds, transmits funds to a governmental entity, and receives money from a development entity.

The water control module 1804 sends signals to controllers to physically control mechanical device that control water. Executing the water control module 1804 (using a processor system) may instruct an actuator to control a dam to block or divert water. The dam may be automatically controlled, such that the water control module 1804 adjusts the flow of water through or around a dam. Water control module 1804 may adjust gates controlling the direction of water flow.

The water control module 1804 may physically affect the flow of water to a mitigation property. Executing the water control module 1804 may cause the actuator to divert water using, for example, valves, hoses, waterways, estuaries, and dams.

The monitoring module 1824 physically monitor the activity and life in a mitigation habitat. Monitoring module 1824 may cause activate one or more cameras, microphones (for recording sounds), water level sensors, water ph sensors, water quality sensors, air quality sensors, and/or moisture sensors, for example. Executing the monitoring module 1824 may cause the actuator to take active steps to monitor the mitigation property.

The automation module 1826 is a function which automates maintenance functions to replace the need for a human. Executing the automation module 1826 may cause the actuator to conduct activities in an automated fashion without human supervision. For instance, if to maintain the watershed, a runoff stream must be blocked after 5 PM, the automation function 1826 may block the run off stream using an actuator. Optionally, various functions may be performed by robots, such as removing invasive species, applying chemicals to remove unwanted plants and/or animals, operating vehicles to transport and introduce species to the habitat species, operating vehicles for digging holes, operating vehicles for constructing structures, and repairing fences. For example, the vehicles of 11A-11E and 14 can be operated robotically. The vehicles of FIGS. 11A and 11H can be programmed to travel in a path that covers a particular region and thereby removes a particular species from that area. The vehicles of FIGS. 11B and 11E can be programmed to automatically travel between the start location and the destination location. The vehicle of FIG. 11 may robotically plant a desired species of a particular area.

The application module 1828 is a function that assists in applying for a government grant for an entity. The application function 1828 may electronically complete necessary forms to apply for a grant in order to expedite the grant application process. Application module 1828 may prompt the user for information needed for filling out the application. The user may input information about the project that is being mitigated by the mitigation project. The application may determine the number of mitigation credits needed to mitigate for the project that necessitates the mitigation and/or the number of mitigation credits generated by the mitigation project. The user may input the location of the site being developed, input various field for work needed to be performed and estimates for performing the work needed to be performed. The user may input descriptions and amounts of expected expenses. Application module 1828 may place the information into the appropriate fields, and determine whether there any requirement fields that still need to be filled out. If there are required fields Application module 1828 may prompt the user for information needed to fill in the required fields.

The government security module 1830 is a function which transmits funds to purchase government securities. The government security module 1830 may transmit data via a server to a network to purchase government securities from a government entity. Government security module 1830 may fill in fields on a form, based on user input, that relate to the amount of the security, the term of the security, the type of security. Government security module 1830 may send a request to a bank to send money to the government entity for purchasing the government security.

The mitigation credit transmitter 1832 may transmit mitigation credits to the development entity. Mitigation credit transmitter 1832 may determine the number of credits a particular monetary amount is equivalent to. The credit transmitter 1832 may transmit mitigation credit documents to a development entity in return for a payment.

The Native American database 1834 may store information relevant to Native American artifacts and remains. The database 1834 may store data representing, for example, locations of Native American items, locations of tribal territories, documents for permission to excavate tribal remains, digital certificates delegating a site as an archaeological site, alternative sites to which Native American items may be repatriated, or contact information for Native American or governmental entity representatives. Database 1834 may include the information indicative of the location that repatriated remains and/or cultural items originated from before being located at a site with the habitat.

The digital detection module 1836 detects whether there are remains or artifacts in a given location. The digital detection module 1836 may use a sensor or imaging device to determine the location of remains or display an image of buried items to allow a user to determine whether remains or cultural artifacts are present at a location. Digital detection module 1836 may include drivers for interfacing with the magnetometer, electrical resistance meter, ground-penetrating radar (GPR), and/or electromagnetic (EM) conductivity meter.

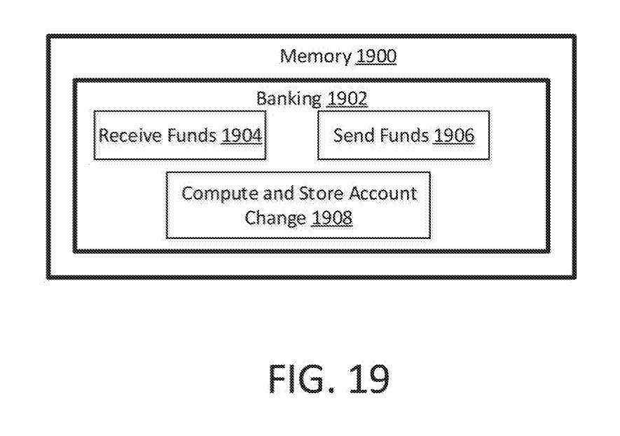

FIG. 19 shows a block diagram of an embodiment of the memory 1900 of a mitigating entity financial institution computer system. The memory 1900 may have a banking module 1902, which may include a receive module 1904, a send module 1906, and a compute and store account changes 1908. In other embodiments, the memory 1900 may not have the element listed and/or may have other elements in addition to or instead of the element listed.

The banking module 1902 may communicate with the mitigation entity, via a network, to act as a financial agent of the mitigation entity. The banking module 1902 may store records of funds and compute interest for the mitigation entity, update the records of the funds by adding the interest to the funds stored, receive a signal from the government entity indicating that the funds for the interest are being transferred to the account of the mitigation entity. The banking module 1902 may transmit or receive funds (e.g., form a government entity or a development entity in exchange for mitigation credits) over a computer network as an agent of the mitigating entity. The banking module 1902 may receive funds from a government grant. The banking module 1902 may transmit funds from a government grant to a government entity to purchase government securities. The banking module 1902 may receive interest on the government securities. The banking module 1902 may be used to pay bills associated with creating restoring, or maintaining the mitigation property.

Receive module 1904 may receive funds from another bank related to the government security. Send module 1906 may send funds to another bank related to the government security. Compute and store account changes 1908 compute the changes to the account balance as a result of deposit, withdrawal, and/or transfer of funds related to the government security.

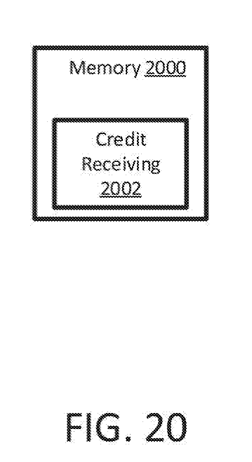

FIG. 20 shows a block diagram of an embodiment of the memory of a development entity server. The memory 2000 may include, for example, a credit receiving module 2002. In other embodiments, the memory 2000 may not have the element listed and/or may have other elements in addition to or instead of the element listed.

The credit receiving module 2002 is a function that receives and stores documents representing mitigation credits from a mitigation entity. The credit receiving module 2002 may receive documents representing mitigation credits, which may offset the environmental impact of a development project conducted by the development entity. Credit receiving module 2002 may request credits to be sent and may request a bank to send money on behalf of the entity receiving the credits as payment for the credits.

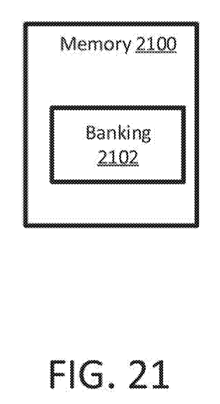

FIG. 21 shows a block diagram of an embodiment of the memory of a development entity financial institution computer system. The memory 2100 may include, for example, a banking module 2102. In other embodiments, the memory 2100 may not have the element listed and/or may have other elements in addition to or instead of the element listed.

The banking module 2102 conducts financial transactions as an agent of the mitigation entity. The banking module 2102 may transmit funds to the mitigation entity or the mitigation entity financial institution.

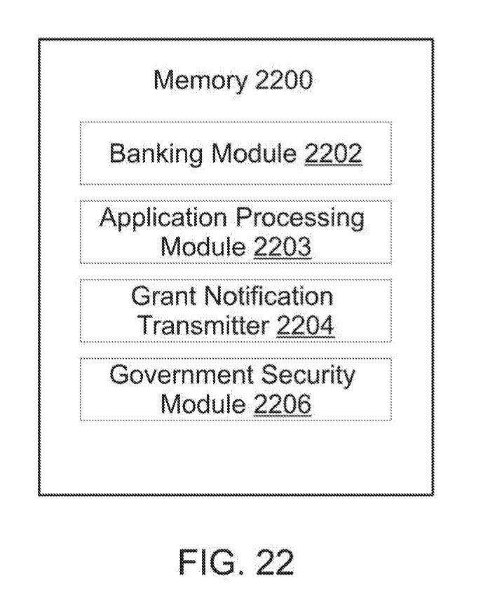

FIG. 22 shows a block diagram of an embodiment of the memory of a governmental entity server. The memory 2200 may include, for example, a banking module 2202, an application processing module 2203, a grant notification transmitter 2204, and a government security module 2206. In other embodiments, the memory 2200 may not have all of the elements listed and/or may have other elements in addition to or instead of the elements listed.

The banking module 2202 is a financial module that manages government monies to be transmitted to or received from private entities. The banking module 2202 may transmit grant funds to the mitigation entity. The banking module 2202 may receive funds for a private entity to purchase government securities. The banking module 2202 may transmit funds to a mitigation entity 104 representing the interest born by the government securities. Banking module 2202 may transmit funds to the server of the financial institution of the mitigation entity 104 in exchange for mitigation credits.

Application processing module 2203 may process applications for mitigation projects. The grant notification transmitter 2204 is a module which notifies a mitigation entity as to whether an application for a grant has been accepted. Governmental entity server may also track and keep records of mitigation projects.

The government security module 2206 is a function which transmits documents representing the purchase and ownership of government securities by mitigation entities. Government security module may also track and keep records about government securities that have issued.

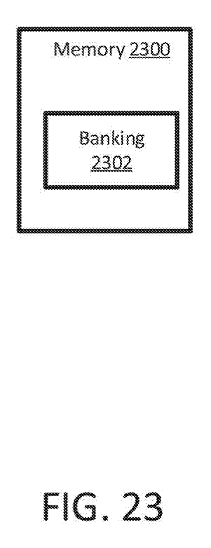

FIG. 23 shows a block diagram of an embodiment of the memory of a governmental entity financial institution computer system. In an embodiment, the governmental entity has an independent financial institution conduct financial transactions for the governmental entity. The memory 2300 may include, for example, a banking module 2302. The banking module 2302 is a financial function that manages government monies to be transmitted to, or received from, private entities. The banking module 2302 may transmit grant funds to the mitigation entity. The banking module 2302 may receive funds for a private entity, such as the mitigation entity 104, to purchase government securities. The banking module 2302 may transmit funds to a mitigation entity 104 as the interest born by the government securities.

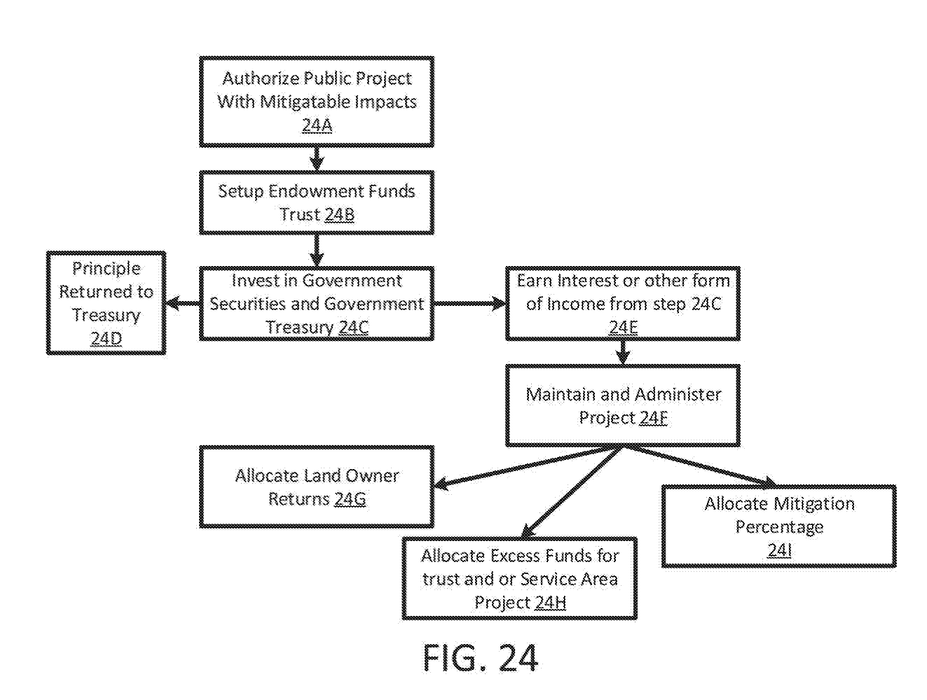

FIG. 24 shows an embodiment of a method for managing endowments. The method 2400 may be employed to protect endowments from routine depletion or invasion, and to return the endowment principal to the sponsoring government for subsequent use. First, in step 24A, a public infrastructure project may be designated by state or federal statues as having mitigatable environmental impacts. Such a designation may require the originating government agency to mitigate the adverse environmental impacts of the project. The particular mitigation requirement—usually a certain number of acres that may be dedicated for wildlife habitats to offset the adverse environmental effects of the project, which may be calculated according to any number of methods. The originating agency may pass the obligation of satisfying the requirement along to the project contractor (or retain the obligation), which may be development entity 108.

In step 24B, the project contractor (or originating agency) may retain a land banking company, which may be mitigation entity 104, to locate suitable real property, develop the real property into a habitat, and maintain real property for perpetuity. The mitigation entity 104 may be any public or private entity. The fees charged by the mitigation entity 104 may be any appropriate amount or percentage. The company may be provided a mitigation endowment, usually set aside from the project contract price, for such purposes. The mitigation endowment may be, but is not required to be, held by the company in perpetual trust. In step 24C, to develop revenue for the wildlife habitat, the mitigation entity 104 may determine appropriate investment instruments for the endowment. Appropriate instruments may be financial instruments offered by the sponsoring government, assuming those instruments are available, assuming those instruments are secure, and assuming those instruments are appropriate for mitigation purposes. For example, if the infrastructure project is funded by the United States Department of Transportation (the “originating government agency” or “originating agency” for the purposes of the embodiment only), the endowment may be invested in suitable financial instruments offered by the United States of America (the “sponsoring government” for the purposes of this example only). On the other hand, if the project is funded by the California Department of Transportation, the endowment may be invested in suitable financial instruments offered by the State of California. If the project is funded in corroboration by both federal and state government agencies, the endowment may be invested in the financial instruments of one government or another, or both, in either proportionate or disproportionate shares. Whether an instrument is secure, appropriate, and/or stable may be determined by any number of methods, such as, but not limited to, reviewing popular market indexes for government-offered financial instruments.

In step 24D, as a result of investing the endowment in the financial instruments of the sponsoring government, the endowment is returned to that government's general treasury. Investing the endowment in a financial instrument of the sponsoring government entity, essentially “recycles” the endowment principal and results in a zero net loss to the sponsoring government—the endowment amount is simply transferred from the originating government agency's infrastructure budget to the sponsoring government's general treasury by way of the mitigation entity 104's investments. Recycling the endowment principal allows the sponsoring government to utilize the endowment amount for any number of other purposes, including the funding of additional infrastructure projects. If the sponsoring government does not offer financial instruments, the endowment may be invested in other available, secure and appropriate financial instruments. For example, if the mitigatable infrastructure project is sponsored by a municipal government (particularly, one that does not offer financial instruments), the appropriate financial instruments may be those offered by the state government, since monies from the state treasury may be spent upon state and local public infrastructure projects, or other projects potentially benefiting the municipality. Alternatively, the endowment may be invested in federal and/or private financial instruments, depending upon the income needs of the habitat.

In step 24E, the mitigation entity 104, as the holder of the financial instruments, receives the interest and profits earned by those instruments. In step 24F, the income is used to develop the wildlife habitat and pay annual expenses of wildlife habitat. To develop the habitat, the mitigation entity 104 locates one or more suitable parcels of real property as sites for the wildlife habitat. The company may obtain an easement over the real property allowing the mitigation entity 104 access to the real property to develop the habitat, either long-term or for perpetuity, in exchange for rents and/or tax incentives. The process of obtaining an easement may occur prior to the first-year return upon the investments, or as depicted herein, after the first-year income has been received. Obtaining the easement after the first-year income has been received allows the mitigation entity 104 to obtain the easement with the interest income, rather than invading the endowment itself. Alternatively, the company may lease the property itself, either long-term or for perpetuity, or purchase the property outright from the owner.

The annual expenses may include, among other things: further development of the habitat, including the purchase of natural resources to create or maintain certain conditions or improvements, such as bodies of water, marshlands or nesting grounds; rental installments, maintenance, operating and/or utility expenses for various equipment; administration fees and salaries; rental payments to the landowner for use of the land; property taxes, if applicable; and licensing fees for use of the present invention (steps 24G-24I).

Because the expenses may be paid from the investment income, there may be a significantly reduced risk of the habitat becoming abandoned or de-funded due to depletion of the endowment. In the event of emergencies or unanticipated expenses (such as natural disasters or environmental damage requiring extensive repairs to the habitat), the endowment may be invaded. However, any invasion of the endowment may be as minimal as possible, and/or temporary. Furthermore, the priority of paying the expenses may be structured so as to further safeguard the endowment. For example, the administration fees and salaries may be paid last. In response, the mitigation entity 104's fees may be reduced accordingly if the wildlife habitat is managed poorly, thereby providing an additional incentive for the mitigation entity 104 to work effectively.

On the other hand, if the income exceeds the habitat's expenses, the mitigation entity 104 may allocate the remaining income in any number of ways. For example, the company may elect to do one or more of the following, in any order: replenish an invaded endowment and/or increase the habitat's endowment in anticipation of future emergencies; distribute the remaining income to the landowner and/or habitat administrators; or fund additional projects designated by the administrators and/or sponsoring government, such as improvements to the existing habitat, alternative habitats for the same or other species, and/or other projects entirely. However, any invasion of the endowment may be replenished immediately so as not to adversely affect future income. Furthermore, given the potential gradual increase of annual expenses over time, a portion of any remaining income should be set aside for additional investments. Upon maturity of the financial instruments, the endowment principal may be “rolled over” or invested in the same, similar, or other suitable instruments offered by the sponsoring government. The rolling over may ensure that the sponsoring government is not deprived of the endowment amount. Thus, the only money potentially removed from the sponsoring government's treasury may be the interest and/or profits that the government pays to the mitigation entity 104 as holder of the financial instruments. The interest the government pays is the same money that the sponsoring government would pay to any other holder of a government-offered financial instrument.

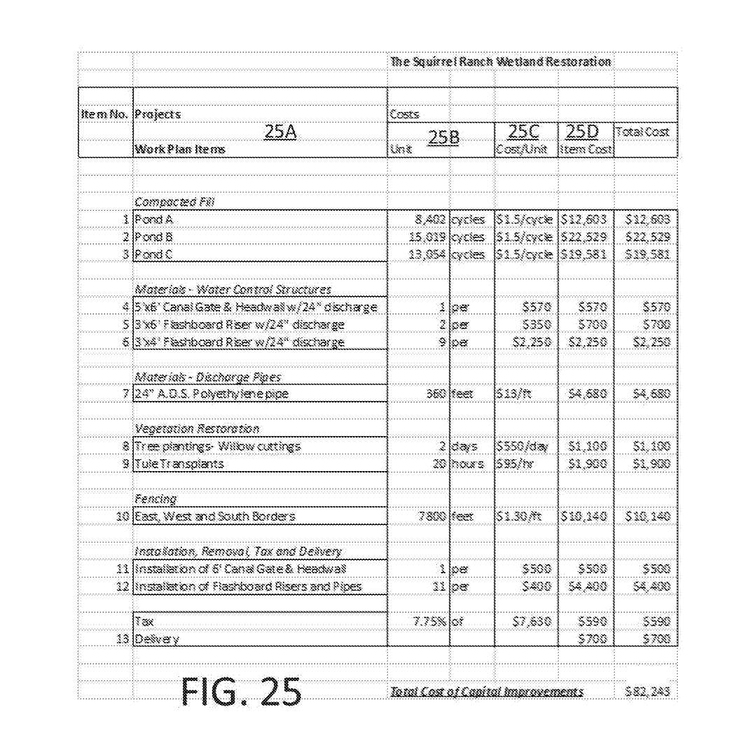

FIG. 25 shows a computerized spreadsheet of an embodiment of the financials associated with a mitigation property (which may be produced on the server of mitigation entity 104). The various items of capital improvement are described in column 25A. The units of labor and/or materials, the cost per unit, and the subtotal for each item of improvement are listed in columns 25B through 25D, respectively. As depicted in cell 25E, the total cost of the capital improvements for the example of FIG. 25 is $82,243.00. The spreadsheet 2500 may be computer generated or may compute some of the values. For instance, the spreadsheet 2500 may use a processor to determine a summation, as is done in FIG. 25 to calculate the total cost of improvements.

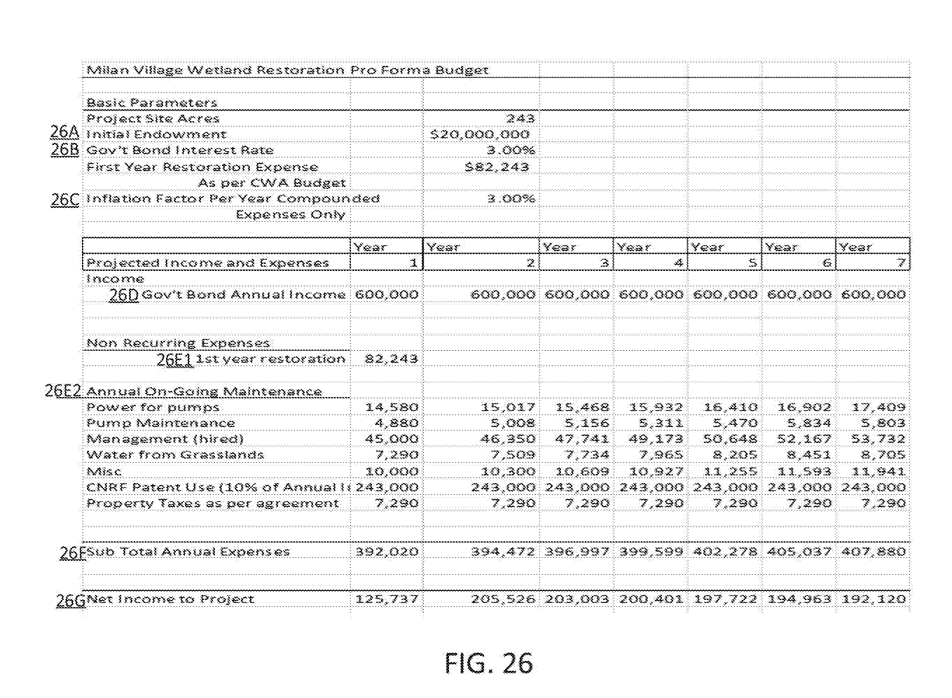

FIG. 26 shows another computerized spreadsheet of an embodiment of a pro forma budget for a wetland restoration project. As depicted therein, the initial endowment amount 26A set aside from the infrastructure project contract price (Step 24B) is twenty million dollars ($20,000,000.00). The endowment is invested in financial instruments of the sponsoring government (Step 24C) bearing an interest rate 26B of three percent (3.00%) per annum. The mitigation entity 104 receives, as income 26D, the interest and/or profits earned from such investments (Step 24E), in the amount of six hundred thousand dollars ($600,000.00) per annum. For purposes of this embodiment, it will be assumed that income is fixed for perpetuity. After receiving the first-year income from investments, the mitigation entity 104 develops (Step 24F) the wildlife habitat. The one-time cost for such capital improvements 26E1, in the amount of $82,243.00, is paid from the first-year income. Additional recurring annual expenses, 26E2 Year-One, are also paid (Steps 24G-24I) from the first-year income—for the purposes of an embodiment, the total of such annual expenses 26F Year-One is $392,020.00. After deducting all of the first-year expenses, the remaining income 26G, Year-One, from the investments is $125,737.00. The remaining income may be used for any of the purposes previously described herein. For subsequent years of operation, it will be assumed for purposes of this example that certain expenses bear a compounded inflation factor 26C of three percent (3.00%) per annum. (See 26G, Years Two through Seven.). This may result from anyone or more of the following: depreciation and/or replacement of habitat equipment; habitat maintenance and restoration expenses; increases in administration salaries or fees; or any number of other reasons. Thus, while the income 26D from the investments continue to exceed the habitat's annual expenses 26E2 for each of the first seven years, it is apparent that the habitat's annual expenses 26E2 will eventually equal, and exceed, the investment income 26D if the latter is not increased. Thus, at least a portion of the net income 26G for each year should be re-invested in appropriate financial instruments to prevent eventual invasion of the endowment. If the interest rate of the government backed security exceeds the inflation rate, then by reinventing an amount of interest equal to or greater than the inflation rate, into the government securities, the fund may be kept indefinitely, and the remainder of the interest can be used for expenses and maintenance of the habitat.

FIG. 27 shows a flowchart of an embodiment of a method 2700 for repatriating Native American remains or cultural artifacts. In step 2702, a determination is made whether a location has Native American remains or artifacts. 2702. In step 2704, an Office of Historic Preservation is notified. In step 2706, permission from the Tribal authority is requested and may be received. In step 2708, permission from the government is requested and may be received. In step 2710, a first registered Native American/archaeological site is created. In step 2712, supervision from a tribal monitor is received. In step 2714, items from the first Native American/archaeological site are excavated. In step 2716, the items excavated are buried at a second registered Native American/archaeological site.

In step 2702, the determining may require a specialist to determine if remains exist. For instance, one may contact the Office of Historical preservation to determine whether the site is located near where tribal villages were located. Also, if remains are found in an area to be developed or flooded in order to make, a coroner may be called to determine the ethnicity of the remains and the flooding may be prevented. Native American remains are accorded special status as culturally important, and the sites with Native American remains may not be disturbed or flooded unless the Native American remains or cultural artifacts are repatriated or moved to a new archaeological site. If the remains and cultural artifacts are found to be of Native American origin, the entity developing the site may be required to inform the Office of Historical preservation.

In step 2704, Notifying the Office of Historic Preservation may include giving notice to a government authority that items of Native American cultural import have been found in a location. If the remains are determined to be Native American, the entity trying to develop the property must notify the Office of Historic Preservation in order to get tribal and/or governmental permission to excavate and repatriate the items of Native American cultural import. The Office of Historic Preservation determines, based on the coordinates of the location, where the Native American items were found which tribes may be affected and which tribes are in a position to give permission to excavate a site, and notify those tribes.

In step 2706, the receiving of the permission from the Tribal authority may include requesting and receiving permission from a Native American authority to repatriate items from a first location to another location. The entity trying to develop the property may be required to present compensation as well as hire tribal supervision in order to get approval.

In step 2708, the receiving of the permission from the government may include getting permission from a government authority. The government authority may grant permission to conduct archaeological activities to repatriate remains.

In step 2710, the creating of a first registered archaeological site may include registering a location as a site of historical significance. Items of importance may be removed from the site if the site creation of the habitat is inconsistent with the manner in which the remains need to be treated. In order to remove Native American remains, a site may be dedicated as an archaeological site from which artifacts may be removed. In an embodiment, although the site may be registered with the Office of Historic Preservation and other regulatory authorities. Nonetheless the location may remain confidential to prevent grave robbery.

In step 2712, the receiving of supervision from a tribal monitor may include a representative of a tribe affected by the repatriation supervising the treatment of the remains. The monitor may be specifically trained to monitor the repatriation or may merely be a member or agent of an affected tribe.

In step 2714, the excavating of items from the first Native American/archaeological site may include digging up items of Native American significance from a site. The excavating of the items may involve digging with a shovel or with a trowel. Hand brushes may be used to remove less desirable elements from the artifacts. In an embodiment, a plum bob and line may be used to determine depth and an angle at which the remains are located relative to the ground. Magnifying glasses may be used to view closely whether elements are artifacts or remains or are merely earth or rocks. Line pins and lines can be used to outline an excavation site area, in order to deter those passing by from entering and/or put all on notice that culturally important items are located within the lined off area. Bone tools are tools made of wood or plastic in order to allow a user to gently excavate bones and other fragile items. The excavation may be conducted by a professional archaeologist. In the case of Native American remains, each body and/or body part may be wrapped carefully. Funeral items that may be buried with a Native American may include, beads, arrowheads, knives, pottery, and other antiquities.

In step 2716, the burying of the items at a second registered archaeological site repatriates the remains to the second approved site. The items removed from the first Native American/archaeological site may be moved to a different Native American/archaeological site and reburied using any of shovels, trowels, backhoes, and the like. The burying of step 2716 may be conducted by a professional archaeologist.

In an embodiment, each of the steps of the method shown in FIG. 27 is a distinct step. In another embodiment, although depicted as distinct steps in FIG. 27, steps 2702-2716 may not be distinct steps. In other embodiments, the method shown in FIG. 27 may not have all of the above steps and/or may have other steps in addition to or instead of those listed above. The steps of the method shown in FIG. 27 may be performed in another order. Subsets of the steps listed above as part of the method shown in FIG. 27 may be used to form their own method. It is a Native American belief among at least some Native American people that burial is a temporary rest before which a coming of a Native American deity resurrects the bodies. The remains and cultural artifacts may be buried respectfully and in such a way so as to prepare adequately for the coming of the Native American deity.

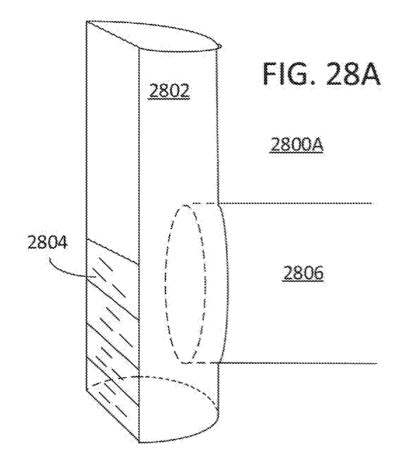

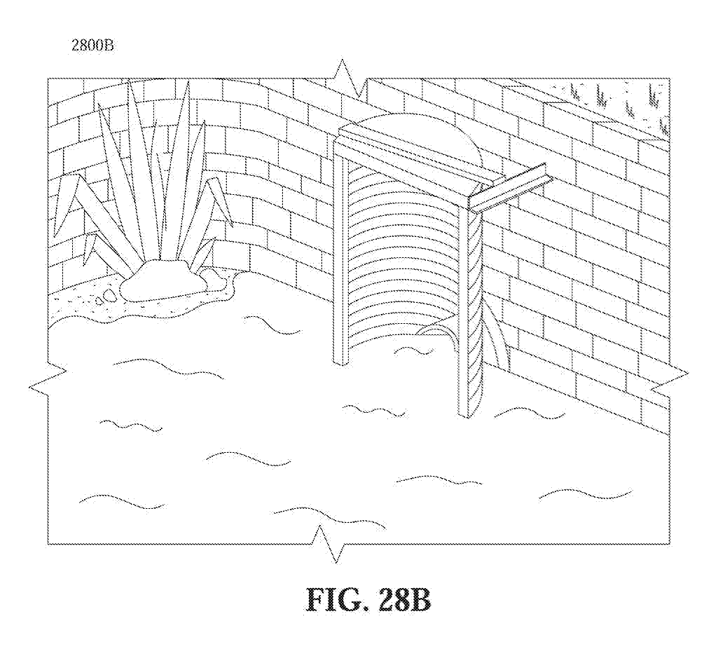

FIGS. 28A-38 illustrate various structures that may be built on a mitigation property for controlling water. The structures of FIGS. 28A-38 may be used as water flow control 630 and/or gate 632 (FIG. 6B). The structures of FIGS. 28A-36 may be used in any of the systems and methods described in the rest of the specification.

FIG. 28A shows a diagram of an embodiment a flashboard riser 2800a. Flashboard riser 2800a may include riser 2802, flashboards 2804 and drain pipe 2806. In other embodiments, the flashboard riser 2800a may not have the element listed and/or may have other elements in addition to or instead of the element listed.

Riser 2800a catches water and directs the water to a drain pipe. Riser 2800a also holds flashboards. Flashboards 2804 are held in place by flashboard riser and determine the height of the water by preventing water from entering the riser until the water is above a certain height (e.g., above the flashboards 2800a). Drain pipe 2806 carries the water from the riser to another location. In FIG. 28A the dashed lines represent portions of the riser 2804 and drawing pipe 2806 that are hidden from view.

FIG. 28B shows an embodiment of a flashboard riser 2800B. Flashboard riser may be an embodiment of flashboard riser 2800a (discussed in conjunction with FIG. 28A). In FIG. 28B the water level is above the flashboards, which are thereby obscured from view. In FIG. 28B, boards may be added or removed to increase or decrease the height of the water at which the water drains. A flashboard riser is a device with risers, which may be raised/added and dropped/removed as appropriate to allow more or less water to pass. The flashboard riser may be a water control structure, which may be used to control the water level or watershed in a mitigation property in any of the above methods.

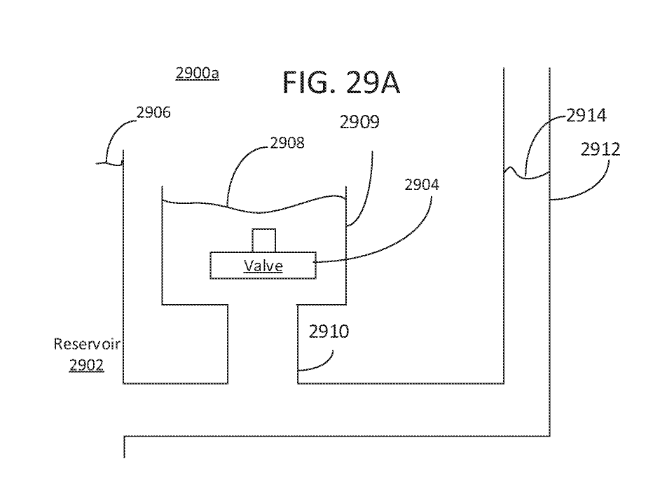

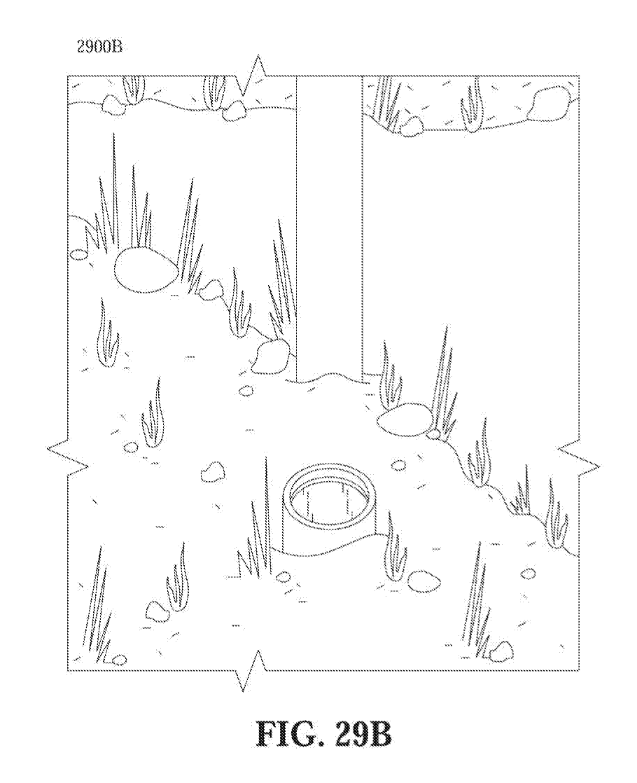

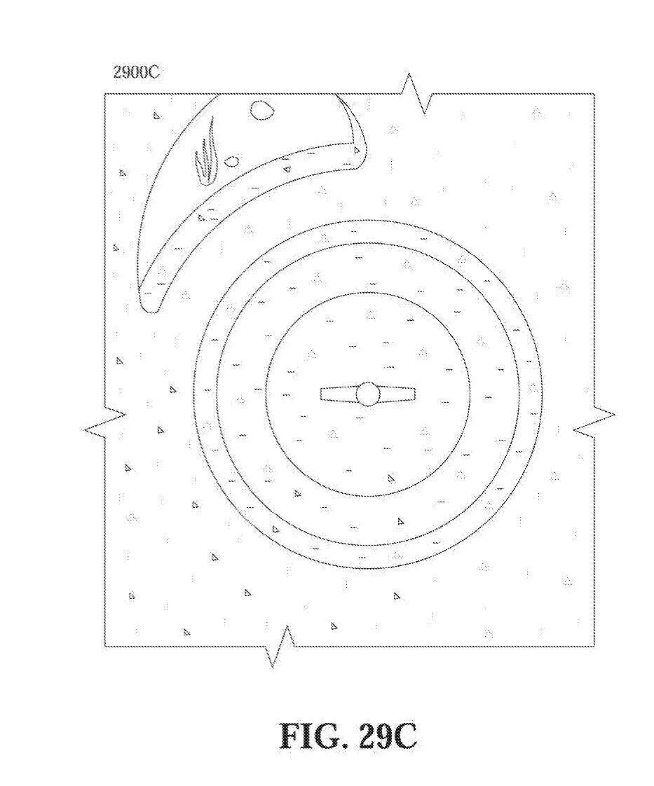

FIG. 29A shows an embodiment of a system 2900a for a reservoir. The system 2900a includes reservoir 2902, valve cover 2904, reservoir water level 2906, escaping water 2908, walls 2909, conduit 2910, vent 2912, vent water level 2914. In other embodiments, system 2900a may not have the element listed and/or may have other elements in addition to or instead of the element listed.

System 2900a is reservoir and release system. Reservoir 2902 may be any body of water in this specification. Valve cover 2904 may act as a valve. When the pressure is high enough, the water pushes the cover up releasing water. Reservoir water lever 2906 is the level of water in the reservoir, which is high enough to open the valve by pushing valve cover 2904 up. Escaping water 2908 is water that escaped from the reservoir, by pushing valve cover open. Walls 2909 keep the valve cover from moving too from the conduit. Conduit 2910 carries the water from reservoir 2902 to valve cover 2904, where the water can escape. Vent 2912 may allow water and air to vent from the conduit. Vent water level 2914 is the level of the water in the vent, which is the same as the water level in reservoir 2902. Ordinarily, the vent 2914 may have no fluids, just air.

FIG. 29B shows an example of a valve and vent of FIG. 29A. The pipeline vent is an assembly which controls the water level while allowing the ventilation of excess fluids.

FIG. 29C shows an embodiment of a concrete valve 2900c with a view of a cap screw valve cover, which may be an embodiment of valve cap 2904. In other embodiments, concrete valve 2900c may not have the element listed and/or may have other elements in addition to or instead of the element listed.

Concrete valve 2900c may be a valve used to control the flow of water. The concrete valve 2900c may be a water control structure which may be used to control the watershed in a mitigation property. The valve may open when the height of the water is high enough to create enough pressure to open the valve. Concreter valve 2900b may be replaced with a valve made from any material. The valve may be weighted according to the height of water/water pressure at which it is desired that the valve open.

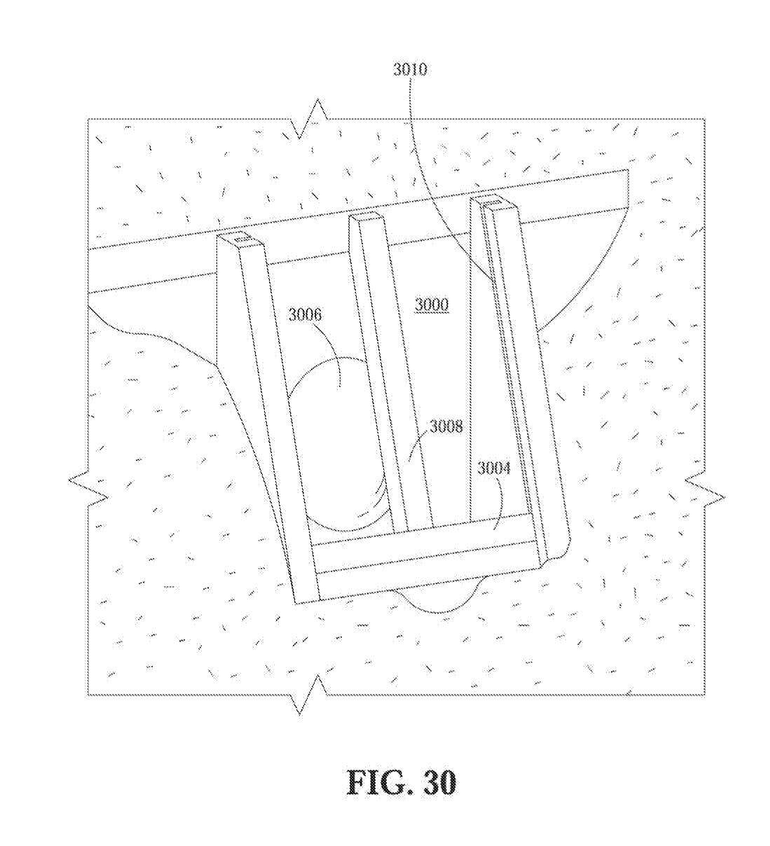

FIG. 30 shows an embodiment of a weir control structure 3000. Weir control structure 3002 includes weir boards 3004, conduit 3006, weir board supports 3008 and 3010, and slots 3012. In other embodiments, control structure 3000 may not have the element listed and/or may have other elements in addition to or instead of the element listed.

Weir control structure 3002 moderates the water level at which water enters a conduit. Weir boards 3004 moderates the rate at which water enters the conduit. Conduit 3006 carries water that passes the weir to another location. Weir supports 3008 and 3010 support weir boards 3004. Weir support 3008 supports the center of weir boards 3004, so that weir boards 3004 are less likely to bend and break. Weir supports 3010 include slot 3012, which hold weir boards in place.

The weir may be built across of stream to control the water level and/or control the course of the water flow. The concrete weir control structure with weir boards 3000 is an assembly that allows passage of some water but restricts the passage of water below the weir board. The weir control structure 3000 may be a water control structure that may be used to control the watershed in a mitigation property.

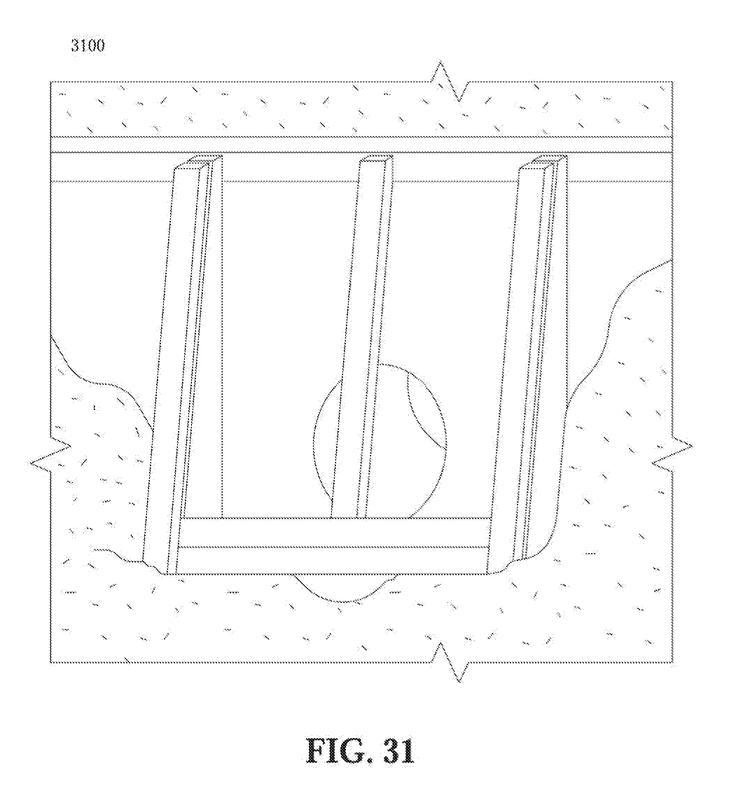

FIG. 31 also shows an embodiment of a weir control structure with weir boards. The concrete weir control structure with weir boards 3100 may be another view of the same concrete weir control structure with weir boards 3000. In other embodiments, the system of FIG. 31 may not have the element listed and/or may have other elements in addition to or instead of the element listed and/or shown in FIG. 31.

The concrete water control weir with weir boards 3100 is a water control structure which may be used to control the watershed in a mitigation property.

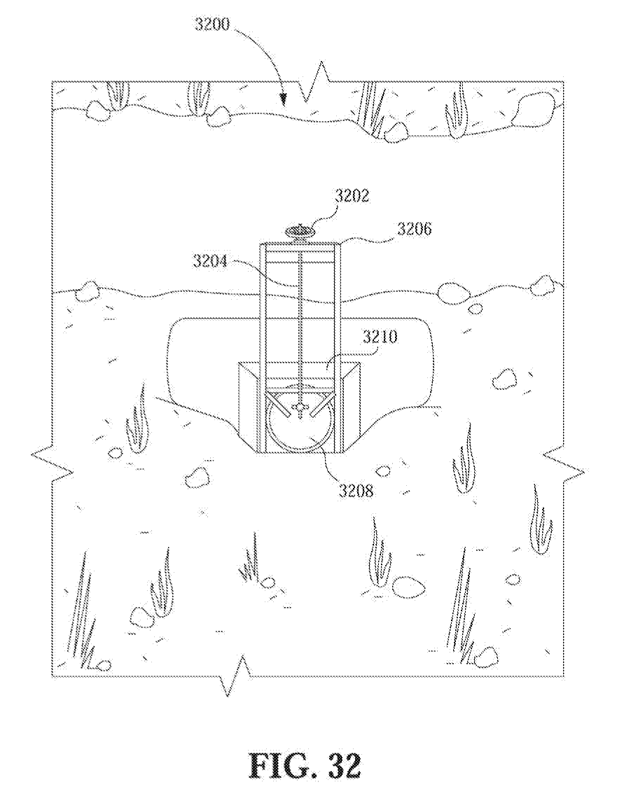

FIG. 32 shows an embodiment of a view of a screw valve control gate 3200. The screw valve control gate 3200 include wheel 3202, screw 3204, frame 3206, gate 3208, and track 3210. In other embodiments, gate 3200 may not have the element listed and/or may have other elements in addition to or instead of the elements listed and/or shown in FIG. 32.

The screw valve control gate 3200 may be used to open and close a gate for allowing water to flow. Wheel 3202 may be used to control the degree to which the gate is open. Screw 3204 is connected to wheel 3202. Turning wheel 3202 turns screw 3204 causes the screw to go up or down pulling up or letting down the gate. Frame 3206 holds screw 3204 and the gate in place. A screw 3204 is threaded through the hole in frame 3204. The hole engages screw 3204 so that turning screw 3204 in the hole causes the screw 3204 to go up or down. Gate 3208 blocks a conduit preventing water to pass through. Gate 3208 is attached to the bottom of screw 3204, so that gate 3208 moves up and down as screw 3204 moves up and down, while being turned. Tracks 3210 are the inner edges of the sides frame 3206. Gate 3208 travels along track 3210 as screw 3204 turns, moving up and down. Screw valve control gate 3200 is an assembly which controls the ingress and egress of water. Turning the wheel turns the screw, and turning the screw opens the valve to allow water to pass. The degree to which the valve is open may be changed by turning the screw. The screw valve control gate 3200 is a water control structure which may be used to control the watershed in a mitigation property.

The screw gate wheel is a controller to open and close water gates. The screw gate wheel may be a water control structure which may be used to control the watershed in a mitigation property.

The screw gate frame is a substrate that holds water gates. The screw gate frame 3200 may be a water control structure that may be used to control the watershed in a mitigation property.

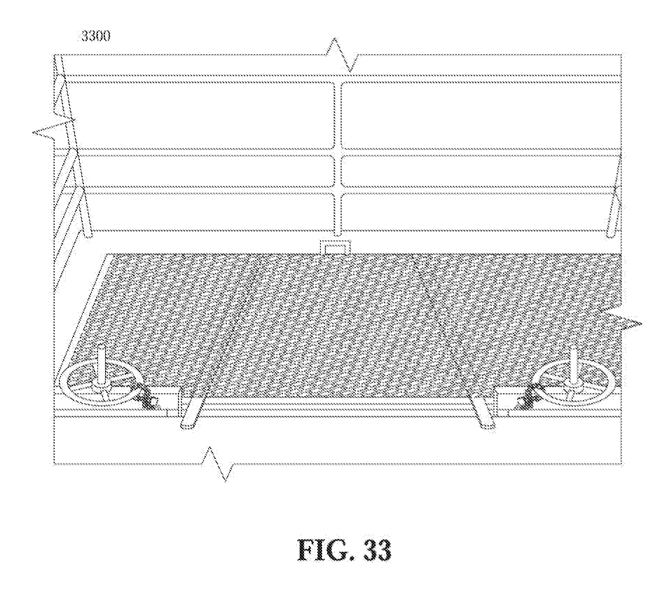

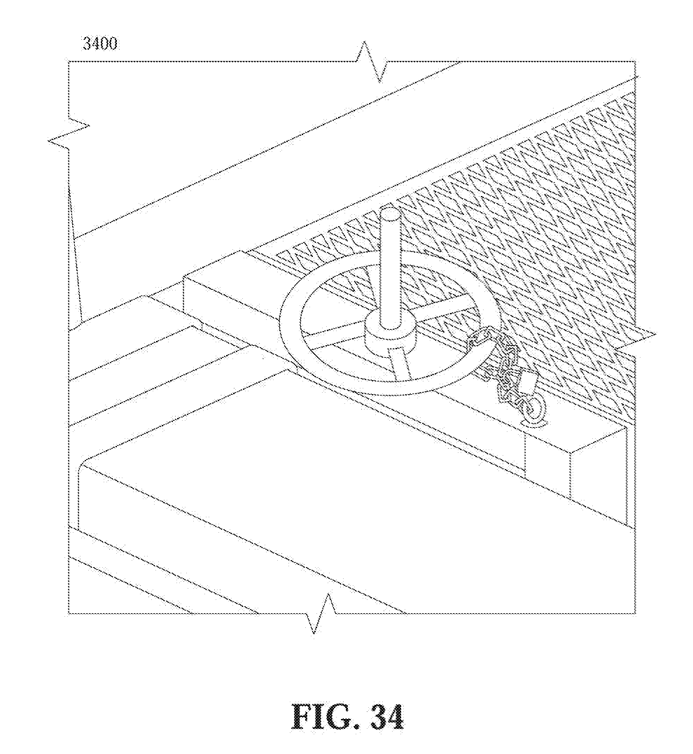

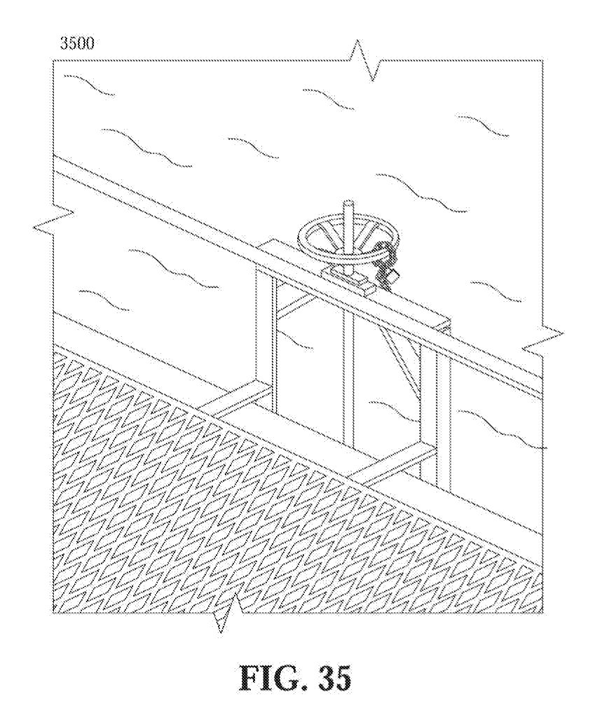

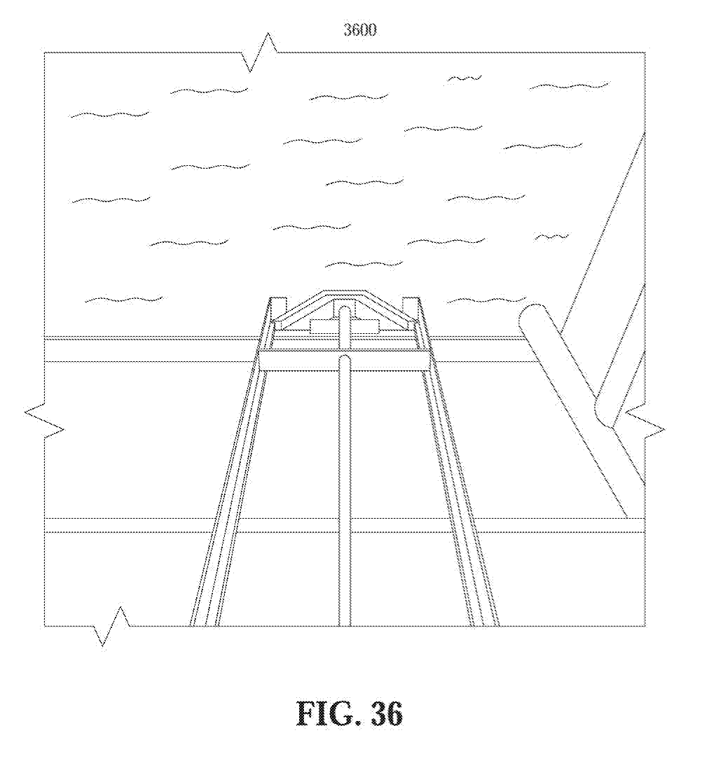

FIGS. 33-36 show the screw wheel and screw of other screw valves. In FIG. 33, the screw gate frame 3300 may be an embodiment of the screw gate frame 3100. The screw gate frame 3300 may be a water control structure which may be used to control the watershed in a mitigation property. In other embodiments, the systems 2900a may not have the element listed and/or may have other elements in addition to or instead of the element listed. FIG. 33 shows a structure having two screw valves. FIGS. 34 and 35 show the top of a single screw valve and FIG. 36 shows a frame supporting the shaft controlled by the wheel at the top of the screw valve of FIG. 35.

### ALTERNATIVES AND EXTENSIONS

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A method of establishing or restoring a wildlife habitat comprising the steps of a private sector entity:
building, on a first real property, a public infrastructure project, the public infrastructure project causing destruction of at least a portion of one habitat of an imperiled or critically imperiled species;
actively and physically transforming the current physical state of a second real property to another physical state, the physical state to which the second real property is transformed being that of the wildlife habitat, the wildlife habitat effectively replacing at least one habitat of an imperiled or critically imperiled species by creating conditions sufficient to sustain the imperiled or critically imperiled species;
erecting a structure that deters usage of the second real property for purposes other than the wildlife habitat, as a first part of the transforming;
maintaining the second real property by, at least, if an element of the second real property falls into disrepair, repairing the element, as a second part of the transforming; and
performing the transforming, erecting, and maintaining of the second real property, on a sustained basis, with income derived from the government security, thereby mitigating a loss of at least a portion of a wildlife habitat as a result of the public infrastructure project.

2. The method of claim 1, further comprising:
receiving,
an endowment from a government entity, by receiving to, at least, offset or reduce environmental effects of the public infrastructure project, and reinvesting the mitigation endowment into a government security offered by the government entity from which the mitigation endowment was received, and
rights to develop a second real property, wherein the rights granted to the second real property for developing the wildlife habitat are separate from rights granted to the public infrastructure project, the second property being located on Native American land;

3. The method of claim 1, the second real property being a location in which Native American remains are located.

4. The method of claim 1, the second real property being a location in which Native American items of cultural importance are located.

5. The method of claim 1, the endowment being a mitigation endowment granted by a governmental agency to mitigate for loss of an imperiled or critically imperiled species.

6. The method of claim 1, the endowment being for creating a multiuse property on the second property, multiple uses of the property including a use as a mitigation habitat and at least one of: a use as a wildlife refuge, a use as a park, a use as a government protected park, a use as an educational park, or a use as a Native American cultural site.

7. The method of claim 1, further comprising repatriating Native American items.

8. A system for mitigating the loss of a species, comprising:
a digging implement to move earth in order to create a mitigation habitat on a mitigation property, the mitigation property being located on real property where Native American artifacts or remains are buried; and
a computer system having a processor and memory, the processor executing functions stored in memory, the functions including:
receiving data representing funds from a grant;
transmitting data representing the funds from the grant to a government entity to receive a government security;
receiving data representing interest payments on the government security from the government entity; and
purchasing, using at least some money from the interest payments, property rights sufficient to allow the creation of the mitigation habitat on the mitigation property.

9. The system of claim 8, the moving earth including:
damming a water source, in order to affect a watershed on the mitigation property; and
physically enclosing the mitigation property using a physical barrier.

10. The system of claim 8, further comprising an imperiled or critically imperiled species which is transplanted to the mitigation property.

11. The system of claim 8, further comprising Native American artifacts or remains which may be repatriated in order to allow the creation of the mitigation habitat on the mitigation property.

12. A method for creating a mitigation site, comprising:
creating a real property via a machine signal for detecting a location of an object under the ground;
determining, via the machine, whether the real property has Native American remains or cultural artifacts, based on the signal;
excavating, by a shovel, Native American remains or cultural items located on the real property if it is determined that the real property has Native American remains or cultural artifacts;
transporting, by a vehicle, the Native American remains or artifacts from the real property to another site, therein repatriating the Native American remains or artifacts; and
creating an enduring mitigation habitat on the real property by at least erecting fencing to reduce traffic into the habitat from a particular direction.

13. The method of claim 12, the creating an enduring mitigation habitat further comprising:
receiving, via a computer system, data representing funds from a government grant for developing the mitigation site;
transmitting, via a computer system, data representing a purchase order to purchase a government security from the government entity; and
receiving, via a computer system, data representing interest paid out from the government security;
wherein the creating an enduring mitigation habitat is funded by interest received from a government security, the government security having been purchased using money from the government grant.

14. The method of claim 12, further comprising transporting, by a vehicle, a species that grazes, to a part of the mitigation site with land that needs to be grazed, and grazing the land with the species that grazes.

15. The method of claim 12, further comprising erecting a dam.

16. The method of claim 12, further comprising receiving government permission to repatriate remains.

17. The method of claim 12, further comprising transporting by a vehicle a desired species, and placing the desired species on the real property in order to create an ecosystem.

18. The method of claim 12, further comprising removing invasive species from the property, the invasive species being a species which threatens an ecosystem of an imperiled or critically imperiled species.

19. The method of claim 12, further comprising erecting a cultural center on the real property to create a multiuse property.

20. The method of claim 12, further comprising erecting walkways to direct foot traffic, in order to minimize environmental impact of visitors.

21. The method of claim 12, further comprising erecting nesting sites for an imperiled or critically imperiled species.

22. The method of claim 12, further comprising wrapping any Native American remains for reburial.
